(19) United States
(12) Patent Application Publication
(10) Pub. No.: US 2017/0208639 A1
(43) Pub. Date: Jul. 20, 2017

(54) METHOD AND APPARATUS FOR CONTROLLING A DEVICE USING BLUETOOTH TECHNOLOGY

(71) Applicant: LG ELECTRONICS INC., Seoul (KR)

(72) Inventors: Minsoo LEE, Seoul (KR); Jingu CHOI, Seoul (KR)

(73) Assignee: LG ELECTRONICS INC., Seoul (KR)

(21) Appl. No.: 15/408,097

(22) Filed: Jan. 17, 2017

Related U.S. Application Data
(60) Provisional application No. 62/278,992, filed on Jan. 15, 2016.

(51) Int. Cl. H04W 76/02; H04W 48/10; H04W 72/04; H04W 4/00

(52) U.S. Cl. CPC H04W 76/023; H04W 4/008; H04W 48/10; H04W 72/0406

(57) ABSTRACT

Disclosed are a method and apparatus for forming, by a first device, a Bluetooth BR/EDR connection with a second device using Bluetooth LE. In an aspect, the method and apparatus transmitting an advertising message to a plurality of devices through Bluetooth LE, wherein the advertising message includes a target address indicating a device which receives the advertising message; receiving a first request message including first control information instructing a Bluetooth BR/EDR connection from the first device indicated by the target address; transmitting a first response message to the first device in response to the first request message; and forming the Bluetooth BR/EDR connection with the first device for providing a specific service.

### CROSS-REFERENCE TO RELATED APPLICATION

This application claims priority to Provisional Application No. 62/278,992 filed on Jan. 15, 2016, which is hereby incorporated by reference in its entirety.

### BACKGROUND OF THE INVENTION

Field of the Invention

The present invention relates to a method and apparatus for connecting alternative communication means using Bluetooth, that is, a short-distance technology, in a wireless communication system and, more specifically, to a method and apparatus for performing a Bluetooth BR/EDR connection using a Bluetooth low energy (BLE) technology and providing a service.

Discussion of the Related Art

Bluetooth is an NFC technology standard allowing various devices to be wirelessly connected in a near field to exchange data. In a case in which two devices intend to perform wireless communication using Bluetooth communication, a user may perform a procedure for discovering a Bluetooth device with which he or she wants to communicate and requesting a connection. In the present disclosure, a device may refer to an apparatus or an appliance.

Here, the user may discover a Bluetooth device according to a Bluetooth communication method intended to be used using the Bluetooth device, and subsequently perform a connection.

The Bluetooth communication method may be classified as a BR/EDR method and an LE method. The BR/EDR method may be termed Bluetooth Classic. The Bluetooth Classic method includes a Bluetooth technology led from Bluetooth 1.0 and a Bluetooth technology using an enhanced data rate (EDR) supported by Bluetooth 2.0 or a subsequent version.

A Bluetooth low energy (LE) technology applied, starting from Bluetooth 4.0, may stably provide information of hundreds of kilobytes (KB) at low power consumption. Such a Bluetooth low energy technology allows devices to exchange information with each other by utilizing an attribute protocol. The Bluetooth LE method may reduce energy consumption by reducing overhead of a header and simplifying an operation.

Among the Bluetooth devices, some products do not have a display or a user interface. Complexity of connection, management, control, and disconnection among various types of Bluetooth devices and Bluetooth device employing similar technologies has increased.

Bluetooth supports a high speed at relatively low power consumption and at relatively low cost. However, since a transmission distance thereof is 100 m at the maximum, and thus, Bluetooth is appropriately used within a limited space.

### SUMMARY OF THE INVENTION

If a device supporting both a Bluetooth BR/EDR method and a Bluetooth LE method in a wireless communication system attempts to perform wireless communication using Bluetooth, the device has to previously determine to perform the wireless communication using which one of the Bluetooth BR/EDR method and the Bluetooth LE method.

Furthermore, a device attempting to perform wireless communication using a determined method has to perform discovery, connection, and data exchange procedures.

However, to determine whether to perform wireless communication using which method deteriorates user convenience because it requires high knowledge for a wireless communication technology.

Furthermore, the Bluetooth BR/EDR requires high consumption power for discovery, connection, and data exchange procedures compared to the Bluetooth LE method.

Accordingly, there is a need for a method for easily recognizing a wireless communication method for a connection and forming a Bluetooth BR/EDR connection through low consumption power.

Accordingly, in order to solve such problems, an embodiment of the present invention provides a method for checking whether each device supports Bluetooth BR/EDR through Bluetooth LE and whether which service can be provided and for performing a Bluetooth BR/EDR connection.

Furthermore, an embodiment of the present invention proposes a method for minimizing power necessary to discover a device using Bluetooth LE.

Furthermore, an embodiment of the present invention proposes an advertising method using a target address in order to enhance security and stability.

Technical objects to be achieved by the present invention are not limited to the aforementioned objects, and those skilled in the art to which the present invention pertains may evidently understand other technological objects from the following description.

In an aspect of the present invention, a method for forming, by a second device, a Bluetooth BR/EDR connection with a first device using Bluetooth LE may include transmitting an advertising message to a plurality of devices through Bluetooth LE, wherein the advertising message includes a target address indicating a device which receives the advertising message; receiving a first request message including first control information instructing a Bluetooth BR/EDR connection from the first device indicated by the target address; transmitting a first response message to the first device in response to the first request message; and forming the Bluetooth BR/EDR connection with the first device for providing a specific service.

In another aspect of the present invention, a second device for forming a Bluetooth BR/EDR connection with a first device using Bluetooth LE includes a communication unit configured to perform communication with an outside in a wired or wireless manner and a processor functionally connected to the communication unit. The processor may be configured to transmit an advertising message to a plurality of devices through Bluetooth LE, wherein the advertising message includes a target address indicating a device which receives the advertising message, to receive a first request message including first control information instructing a Bluetooth BR/EDR connection from the first device indicated by the target address, to transmit a first response message to the first device in response to the first request message, and to form the Bluetooth BR/EDR connection for providing a specific service with the first device.

The first request message and the first response message may be transmitted through an advertising channel using the Bluetooth LE.

The method may further include forming a Bluetooth LE connection with the first device based on the advertising message.

Forming the Bluetooth LE connection may include receiving a second request message to request the Bluetooth LE connection from the first device in response to the advertising message. The Bluetooth LE connection may be formed between the first device and the second device based on the second request message.

The target address may indicate of a public address or a random address. The public address or the random address may indicate an address used when the first device and the second device perform a bonding procedure.

The advertising message may further include at least one of a state information indicating an on or off of Bluetooth BR/EDR, a service list information indicating at least one of service capable of providing through the Bluetooth BR/EDR, or an ID information indicative of the second device.

The ID information indicating the second device may indicate a public address or a random address. The public address or the random address may indicate an address used when the first device and the second device perform a bonding procedure.

The first request message may be transmitted by the first device based on the ID information.

If the specific service is a data synchronization service, the first request message may include second control information instructing the activation of the data synchronization function of the second device.

The method may further include receiving a third request message to request the writing of data for providing the data synchronization service from the first device through the Bluetooth LE, wherein the third request message includes the data, and transmitting a second response message to the first device in response to the third request message.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic view illustrating an example of a wireless communication system using a Bluetooth low energy technology to which the present invention is applicable.

FIG. 2 shows an example of the internal block diagram of a device to which an embodiment of the present invention may be applied.

FIG. 3 is a view illustrating an example of a Bluetooth low energy topology.

FIGS. 4 and 5 are diagrams showing examples of Bluetooth communication architecture to which an embodiment of the present invention may be applied.

FIG. 6 is a diagram showing an example of the structure of a Generic Attribute Profile (GATT) for Bluetooth LE.

FIG. 7 is a diagram showing a discovery and connection procedure using the Bluetooth BR/EDR.

FIG. 8 is a diagram showing a discovery and connection procedure using a Bluetooth LE method.

FIG. 9 a diagram showing the state diagram of a link controller and link layer according to a Bluetooth compatibility communication method.

FIG. 10 is a diagram for illustrating a problem occurring in a device discovery method using existing Bluetooth communication.

FIG. 11 is a diagram schematically showing a Bluetooth BR/EDR connection procedure through a Bluetooth LE method.

FIG. 12 is a diagram showing an example in which a message is transmitted and received between network interfaces for connecting alternative communication means through a Bluetooth LE method to which an embodiment of the present invention may be applied.

FIG. 13 is an embodiment to which the present invention may be applied and is a diagram for illustrating an advertising method for connecting alternative communication means through a Bluetooth LE method.

FIG. 14 is an embodiment to which the present invention may be applied and is a diagram for illustrating a method for connecting to a device set as a target address.

FIG. 15 is an embodiment to which the present invention may be applied and is a diagram showing a method for connecting to a device having a target address by sending an advertising message into which the target address has been inserted.

FIG. 16 is an embodiment to which the present invention may be applied and is a diagram illustrating an advertising packet including a target address field.

FIG. 17 is an embodiment to which the present invention may be applied and is a diagram showing an example of a Bluetooth BR/EDR connection mechanism using a Bluetooth LE method.

FIG. 18 is an embodiment to which the present invention may be applied and is a diagram showing a method for performing a Bluetooth BR/EDR connection using a Bluetooth LE method.

FIG. 19 is an embodiment to which the present invention may be applied and is a diagram showing a method for performing a Bluetooth BR/EDR connection using a Bluetooth LE method.

FIG. 20 is an embodiment to which the present invention may be applied and is a diagram showing a method for performing a Bluetooth BR/EDR connection using a Bluetooth LE method.

FIG. 21 is an embodiment to which the present invention may be applied and is a diagram showing a method for performing a data synchronization service using a Bluetooth LE method.

FIG. 22 is an embodiment to which the present invention may be applied and is a diagram for illustrating a BR/EDR information exchange and handover method using a Bluetooth LE method.

FIG. 23 is an embodiment to which the present invention may be applied and is a diagram showing a method for performing a Bluetooth BR/EDR connection using a Bluetooth LE method.

FIG. 24 is a diagram schematically showing an example of handover from a Bluetooth LE method to a Bluetooth BR/EDR method, which is proposed by this specification.

### DETAILED DESCRIPTION OF THE EMBODIMENTS

The aforementioned objects, features and advantages of the present invention will become more apparent through the following detailed description with respect to the accompanying drawings. Hereinafter, the embodiments of the present invention will be described with reference to the accompanying drawings, in which like numbers refer to like elements throughout the specification. In describing the present invention, a detailed description of known techniques associated with the present invention unnecessarily obscure the gist of the present invention, it is determined that the detailed description thereof will be omitted.

Hereinafter, a terminal related to the present invention will be described in detail with reference to the accompanying drawings. In the following description, usage of suffixes such as ‘module’, ‘part’ or ‘unit’ used for referring to elements is given merely to facilitate explanation of the present invention, without having any significant meaning by itself.

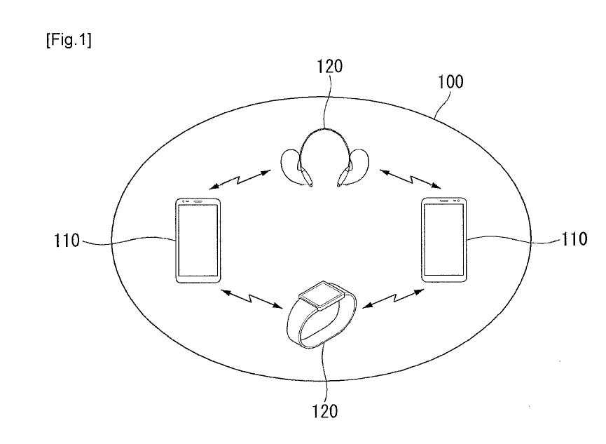

FIG. 1 is a schematic view illustrating an example of a wireless communication system using a Bluetooth low energy technology to which the present invention is applicable.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may also be called as data service device, slave device, slave, server, conductor, host device, gateway, sensing device, monitoring device, first device, or the like, and the client device 110 may also be called as master device, master, client, member, sensor device, sink device, collector, second device, third device, and the like.

The server device and the client device correspond to major components of the wireless communication system, and the wireless communication system may include components other than the server device and the client device.

The server device refers to a device which receives data from the client device and provides data to the client device in response when a corresponding request is received from the client device, through direct communication with the client device.

Also, in order to provide data information to the client device, the server device sends a notification message or an indication message to the client device in order to provide data information to the client device. Also, the server device receives a confirmation message corresponding to the indication message from the client device.

Also, in the process of transmitting and receiving notification, indication, and confirmation messages to and from the client device, the server device may provide data information to a user through a display unit or may receive a request input from the user through a user input interface.

Also, in the process of transmitting and receiving message to and from the client device, the server device may read data from a memory unit or may write new data to the corresponding memory unit.

Also, the single server device may be connected with a plurality of client devices, and may be easily re-connected with client devices using bonding information.

The client device 120 refers to a device which requests data information and data transmission from the server device.

The client device receives data through a notification message or an indication message from the server device, and when an indication message is received from the server device, the client device sends an acknowledgement message in response to the indication message.

Similarly, in the process of transmitting and receiving messages to and from the server device, the client device may also provide information to the user through a display unit or may receive an input from the user through a user input interface.

Also, in the process of transmitting and receiving messages with the server device, the client device may read data from a memory unit or may write new data to the corresponding memory unit.

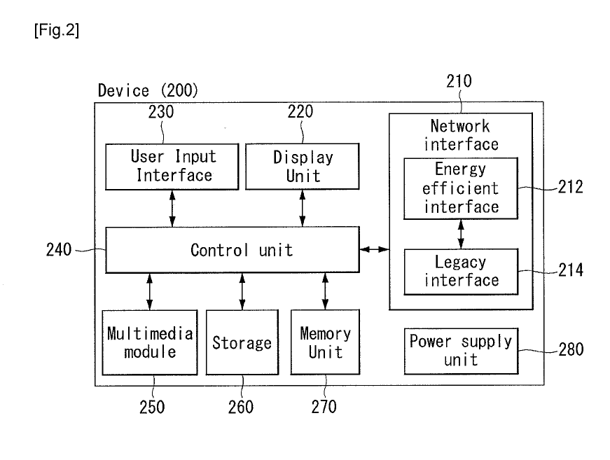

Hardware components such as the display units, the user input interfaces, and the memory units of the server device and the client device will be described in detail with reference to FIG. 2.

Also, the wireless communication system may configure personal area networking (PAN) through the Bluetooth technology. For example, in the wireless communication system, a private piconet may be established between devices to quickly and safely exchange files, documents, and the like.

Also, a plurality of devices measuring exercising activities of human beings through a fitness equipment using a specific device have been presented, but a device transmitting measured exercising data through Bluetooth to show specific numerical values to users has not been introduced yet.

Thus, the present invention proposes a method for measuring human beings' exercising activities through the fitness equipment and transmitting and processing measured data through Bluetooth LE to provide the processed data to users.

FIG. 2 shows an example of the internal block diagram of a device to which an embodiment of the present invention may be applied.

As shown in FIG. 2, a device 200 proposed by an embodiment of the present invention may include a network interface 210, a display unit 220, a user input interface 230, a control unit 240, a multimedia module 250, storage 260, a memory unit 270, and a power supply unit 280.

The network interface 210, the display unit 220, the user input interface 230, the control unit 240, the multimedia module 250, the storage 260, the memory unit 270, and the power supply unit 280 are functionally connected to perform a method proposed by this specification.

The network interface 210 refers to an apparatus that enables the device to perform wired or wireless communication with another device, and may include an energy efficient interface 212 and a legacy interface 214.

The energy efficient Interface 212 is an apparatus for low power wireless communication having low energy consumption, and refers to a unit (or a module) for discovering another device to be connected to the device or enabling data transmission.

The legacy interface 214 is an apparatus for wireless communication, and refers to a unit (or a module) for discovering another device to be connected to the device and enabling data transmission.

The network interface may also be called a communication unit.

The display unit 220 refers to a unit (or a module) for outputting data received through the network interface 210 or data stored in the storage 260 under the control of the control unit 240.

The control unit 240 refers to a module for controlling an overall operation of the device. The control unit 240 may also be expressed as a control unit, a processor or a controller.

The control unit 240 may include application-specific integrated circuits (ASICs), other chipsets, logic circuits and/or data processing devices.

The control unit 240 controls the network interface 210 so that it receives an advertising message from another device, controls the communication unit so that it sends a scan request message to another device and receives a scan response message as a response to the scan request from another device, and controls the network interface so that it sends a connection request message to the server device for a Bluetooth connection with another device.

Furthermore, after a Bluetooth LE connection is established through the connection procedure, the control unit 240 controls the communication unit so that it reads or writes data from or in another device using the attribute protocol.

The multimedia module 250 is a unit (or module) for the playback of a variety of types of multimedia. The multimedia module 250 may be implemented within the control unit 240 or separately.

The storage 260 is a unit implemented in a variety of types of devices, and refers to a unit of a nonvolatile property which is capable of storing a variety of types of data.

The memory unit 270 is a unit implemented in a variety of types of devices, and refers to a unit of a volatile property in which a variety of types of data is temporarily stored.

The memory unit 270 may include read-only memory (ROM), random access memory (RAM), flash memory, a memory card, a storage medium and/or other storage devices.

The wireless communication network 210 may include a baseband circuit for processing a radio signal. When an embodiment is implemented in software, the aforementioned scheme may be implemented using a module (or process or function) for performing the aforementioned function. The module may be stored in the memory unit 270 or the storage 260 and executed by the processor.

The memory unit 270 may be disposed inside or outside the control unit 240 and may be connected to the control unit 240 by well-known means.

The power supply unit 280 refers to a module for being supplied with external power, internal power under the control of the control unit 240 and supplying power for the operation of each element.

As described above, the BLE technology has a low duty cycle and can significantly reduce power consumption through a low data transfer rate. Accordingly, the power supply unit can supply power for the operation of each element even with low output power (e.g., 10 mW or less).

The user input interface 230 refers to a module which provides a user input to the control unit 240 along with a screen button so that a user can control the operation of the device.

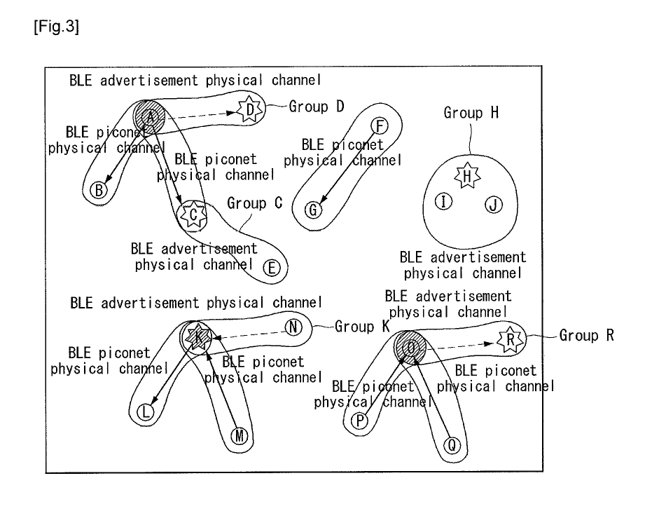

FIG. 3 is a view illustrating an example of a Bluetooth low energy topology.

Referring to FIG. 3, a device A corresponds to a master in a piconet (piconet A, the shaded portion) having a device B and a device C as slaves.

Here, the piconet refers to an aggregation of devices in which any one of them is a mater and the other devices occupy a shared physical channel connected to the master device.

The BLE slaves do not share a common physical channel with the master. Each of the slaves communicates with the master trough a separate physical channel. There is another piconet (piconet F) having a master device F and a slave device G.

A device K is present in a scatternet K. Here, the scatternet refers to a group of piconets connected to other piconets.

The device K is a master of a device L and a slave of a device M.

A device O is also in the scatter net O. The device O is a slave of a device P and a slave of a device Q.

As illustrated in FIG. 2, five different device groups are present.

Device D is an advertiser and device A is an initiator (group D).

Device E is a scanner and Device C is an advertiser (group C).

Device H is an advertiser, and devices I and J are scanners (group H).

Device K is also an advertiser, and device N is an initiator (group K).

Device R is an advertiser, and device O is an initiator (group R).

The devices A and B use a single BLE piconet physical channel.

The devices A and C use another BLE piconet physical channel.

In group D, the device D advertises using an advertisement event connectable in an advertisement physical channel, and the device A is an initiator. The device A may establish a connection with the device D and add a device to the piconet A.

In group C, the device C advertises on an advertisement physical channel by using a certain type of an advertisement event captured by the scanner device E.

The group D and the group C may use different advertisement physical channels or different times in order to avoid collision.

In the piconet F, a single physical channel is present. The devices F and G use a single BLE piconet physical channel. The device F is a master, and the device G is a slave.

In group H, a single physical channel is present. The devices H, I, and J use a single BLE advertisement physical channel. The device H is an advertiser, and the devices I and J are scanners.

In the scatternet K, the devices K and L use a single BLE piconet physical channel. The devices K and M use another BLE piconet physical channel.

In group K, the device K advertises by using an advertisement event connectable on an advertisement physical channel, and the device N is an initiator. The device N may establish a connection with the device K. Here, the device K may be a slave of two devices and a master of one device at the same time.

In the scatternet O, the devices O and P use a single BLE piconet physical channel. The devices O and Q use another BLE piconet physical channel.

In group R, the device R advertises by using an advertisement event connectable on an advertisement physical channel, and the device O is an initiator. The device O may establish a connection with the device R. Here, the device O may be a slave of two devices and a master of one device at the same time.

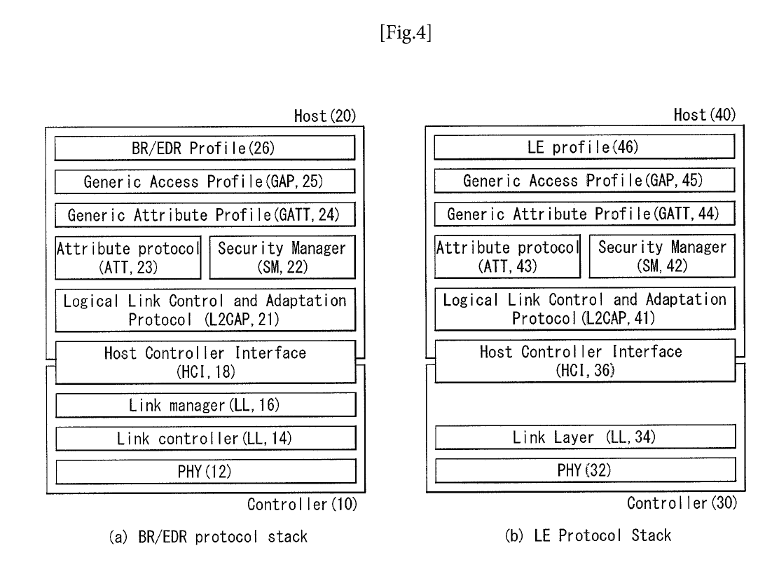

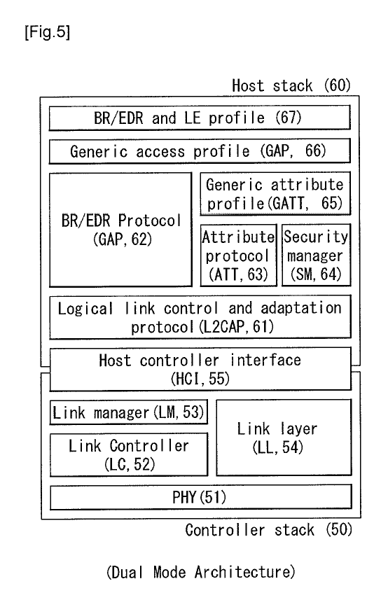

FIGS. 4 and 5 are diagrams showing examples of Bluetooth communication architecture to which an embodiment of the present invention may be applied.

Referring to FIGS. 4 and 5, FIG. 4(a) shows an example of a Bluetooth basic rate (BR)/enhanced data rate (EDR) protocol stack, and FIG. 4(b) shows an example of a Bluetooth low energy (LE) protocol stack.

Furthermore, FIG. 5(c) shows an example of dual mode architecture for supporting both the Bluetooth BR/EDR and the Bluetooth LE.

More specifically, as shown in FIG. 4(a), the Bluetooth BR/EDR protocol stack may include an upper host stack 20 and a lower controller stack 10 on the basis of a host controller interface (HCI) 14.

The controller stack 10 refers to a wireless transmission and reception module for receiving a Bluetooth signal of 2.4 GHz and hardware for sending or receiving a Bluetooth packet. The host stack 20 is connected to a Bluetooth module, and controls the Bluetooth module and performs an operation.

The controller stack 10 may include a BR/EDR PHY layer 11, a BR/EDR baseband layer 12, and a link manager layer 13.

The BR/EDR PHY layer 11 is a layer for sending and receiving a radio signal of 2.4 GHz. If Gaussian frequency shift keying (GFSK) modulation is used, the BR/EDR PHY layer 11 may send data by hopping 79 RF channels.

The BR/EDR Baseband layer 12 is responsible for a function for sending a digital signal, and selects a channel sequence that is hopped 1,400 times per second and sends a time slot of 625 us in length for each channel.

The link manager layer 13 controls an overall operation (e.g., link setup, control, and security) for a Bluetooth connection using a link manager protocol (LMP).

The link manager layer 13 may perform the following functions.
The link manager layer 16 may perform ACL/SCO logical transport, logical link setup, and control
Detach: The link manager layer 16 stops connection and informs a counterpart device about the reason for stopping connection.
The link manager layer 16 performs power control and role switch.
The link manager layer 16 performs security (authentication, pairing, encryption) function.

The host controller interface layer 14 provides an interface between the host stack and the controller stack so that a host can provide a command and data to a controller and the controller can provide an event and data to the host.

The host stack (or host module) 20 includes a logical link control and adaptive protocol (L2CAP) 21, a BR/EDR protocol 22, a generic access profile (GAP) 23, and a BR/EDR profile 24.

The logical link control and adaptive protocol (L2CAP) 21 may provide a two-way channels for transmitting data to a specific protocol or a profile.

The L2CAP 21 may multiplex various protocols and profiles provided from a Bluetooth higher position.

The L2CAP of the Bluetooth BR/EDR uses a dynamic channel, supports a protocol service multiplexer, retransmission, and a streaming mode, and provides segmentation and reassembly, per-channel flow control, and error control.

The BR/EDR protocol 22 and the BR/EDR profile 24 define a service (or profile) using the Bluetooth BR/EDR and defines an application protocol for the exchange of such data. The generic access profile (GAP) 23 defines a device discovery, connection, and security level.

The Bluetooth LE protocol stack shown in FIG. 4(b) includes a controller stack 30 capable of operating to process a wireless device interface whose timing is important and a host stack 40 capable of operating to process high level data.

First, the controller stack 30 may be implemented using a communication module which may include a Bluetooth wireless device, for example, a processor module which may include a processing device, such as a microprocessor.

The host stack 40 is part of an OS operating on the processor module and may be implemented as the instantiation of a package on the OS.

In some instances, the controller stack and the host stack may be driven or executed on the same processing device within the processor module.

The controller stack 30 includes a physical layer (PHY) 31, a link layer (LL) 32, and a host controller interface (HCI) 33.

The physical layer (PHY or a wireless transmission and reception module) 31 is a layer for sending and receiving a radio signal of 2.4 GHz, and uses GFSK modulation and a frequency hopping scheme including 40 RF channels.

The link layer 32 that functions to send or receive a Bluetooth packet performs advertising and scanning functions using 3 advertising channels, and provides a function for generating a connection between devices and exchanging data packets of a maximum of 257 bytes through 37 data channels.

The host stack 40 may include a logical link control and adaptive protocol (L2CAP) 41, a security manager (SM) 42, an attribute protocol (ATT) 43, a generic attribute profile (GATT) 44, a generic access profile (GAP) 45, and an LE profile 46. The host stack 40 is not limited to the protocols and profiles, but may include various protocols and profiles.

The host stack 40 multiplexes various protocols and profiles provided higher Bluetooth using the L2CAP.

First, the L2CAP 41 may provide a single bidirectional channel for sending data to a specific protocol or profile.

The L2CAP 41 may operate to multiplex data between higher layer protocols, to segment and reassemble packages, and to manage multicast data transmission.

In the Bluetooth LE, three basic channels (e.g., one for a signaling CH, one for a security manager, and one for an attribute protocol) are basically used. Furthermore, a dynamic channel may be used, if necessary.

In contrast, in the BR/EDR, a dynamic channel is basically used. A protocol service multiplexer, retransmission, streaming mode, etc. are supported.

The security manager (SM) 42 is a protocol for authenticating a device and providing a key distribution.

The attribute protocol (ATT) 43 is a server-client structure, and defines a rule for accessing the data of a counterpart device. The ATT has the following 6 message types (i.e., Request, Response, Command, Notification, indication, and Confirmation).
Request and Response message: A request message is a message for a client device to request specific information from a server device, and the response message, as a response message with respect to the request message, refers to a message transmitted from the server device to the client device.
Command message: It is a message transmitted from the client device to the server device in order to indicate a command of a specific operation. The server device does not transmit a response with respect to the command message to the client device.
Notification message: It is a message transmitted from the server device to the client device in order to notify an event, or the like. The client device does not transmit a confirmation message with respect to the notification message to the server device.
Indication and confirmation message: It is a message transmitted from the server device to the client device in order to notify an event, or the like. Unlike the notification message, the client device transmits a confirmation message regarding the indication message to the server device.

In the present invention, when the GATT profile using the attribute protocol (ATT) 43 requests long data, a value regarding a data length is transmitted to allow a client to clearly know the data length, and a characteristic value may be received from a server by using a universal unique identifier (UUID).

The generic access profile (GAP) 45, a layer newly implemented for the Bluetooth LE technology, is used to select a role for communication between Bluetooth LED devices and to control how a multi-profile operation takes place.

Also, the generic access profile (GAP) 45 is mainly used for device discovery, connection generation, and security procedure part, defines a scheme for providing information to a user, and defines types of attributes as follows.
Service: It defines a basic operation of a device by a combination of behaviors related to data
Include: It defines a relationship between services
Characteristics: It is a data value used in a server
Behavior: It is a format that may be read by a computer defined by a UUID (value type).

The LE profile 46, including profiles dependent upon the GATT, is mainly applied to a Bluetooth LE device. The LE profile 46 may include, for example, Battery, Time, FindMe, Proximity, Time, Object Delivery Service, and the like, and details of the GATT-based profiles are as follows.

Battery: Battery information exchanging method

Time: Time information exchanging method

FindMe: Provision of alarm service according to distance

Proximity: Battery information exchanging method

Time: Time information exchanging method

The generic attribute profile (GATT) 44 may operate as a protocol describing how the attribute protocol (ATT) 43 is used when services are configured. For example, the GATT 44 may operate to define how ATT attributes are grouped together with services and operate to describe features associated with services.

Thus, the GATT 44 and the ATT 43 may use features in order to describe status and services of a device and describe how the features are related and used.

FIG. 5(c) shows dual mode architecture supporting both the Bluetooth BR/EDR and the Bluetooth LE.

An embodiment of the present invention proposes a method for discovering a device that supports the Bluetooth BR/EDR through the Bluetooth LE having small power consumption and establishing a Bluetooth BR/EDR connection by exchanging information for a Bluetooth BR/EDR connection in order to reduce power consumption when a Bluetooth BR/EDR connection is formed in a device that supports both the Bluetooth BR/EDR and the Bluetooth LE.

Hereinafter, procedures of the Bluetooth low energy (BLE) technology will be briefly described.

The BLE procedure may be classified as a device filtering procedure, an advertising procedure, a scanning procedure, a discovering procedure, and a connecting procedure.

Device Filtering Procedure

The device filtering procedure is a method for reducing the number of devices performing a response with respect to a request, indication, notification, and the like, in the controller stack.

When requests are received from all the devices, it is not necessary to respond thereto, and thus, the controller stack may perform control to reduce the number of transmitted requests to reduce power consumption.

An advertising device or scanning device may perform the device filtering procedure to limit devices for receiving an advertising packet, a scan request or a connection request.

Here, the advertising device refers to a device transmitting an advertisement event, that is, a device performing an advertisement and is also termed an advertiser.

The scanning device refers to a device performing scanning, that is, a device transmitting a scan request.

In the BLE, in a case in which the scanning device receives some advertising packets from the advertising device, the scanning device should transmit a scan request to the advertising device.

However, in a case in which a device filtering procedure is used so a scan request transmission is not required, the scanning device may disregard the advertising packets transmitted from the advertising device.

Even in a connection request process, the device filtering procedure may be used. In a case in which device filtering is used in the connection request process, it is not necessary to transmit a response with respect to the connection request by disregarding the connection request.

Advertising Procedure

The advertising device performs an advertising procedure to perform undirected broadcast to devices within a region.

Here, the undirected broadcast is advertising toward all the devices, rather than broadcast toward a specific device, and all the devices may scan advertising to make an additional information request or a connection request.

In contrast, directed advertising may make an additional information request or a connection request by scanning advertising for only a device designated as a reception device.

The advertising procedure is used to establish a Bluetooth connection with an initiating device nearby.

Or, the advertising procedure may be used to provide periodical broadcast of user data to scanning devices performing listening in an advertising channel.

In the advertising procedure, all the advertisements (or advertisement events) are broadcast through an advertisement physical channel.

The advertising devices may receive scan requests from listening devices performing listening to obtain additional user data from advertising devices. The advertising devices transmit responses with respect to the scan requests to the devices which have transmitted the scan requests, through the same advertising physical channels as the advertising physical channels in which the scan requests have been received.

Broadcast user data sent as part of advertising packets are dynamic data, while the scan response data is generally static data.

The advertisement device may receive a connection request from an initiating device on an advertising (broadcast) physical channel. If the advertising device has used a connectable advertising event and the initiating device has not been filtered according to the device filtering procedure, the advertising device may stop advertising and enter a connected mode. The advertising device may start advertising after the connected mode.

Scanning Procedure

A device performing scanning, that is, a scanning device performs a scanning procedure to listen to undirected broadcasting of user data from advertising devices using an advertising physical channel.

The scanning device transmits a scan request to an advertising device through an advertising physical channel in order to request additional data from the advertising device. The advertising device transmits a scan response as a response with respect to the scan request, by including additional user data which has requested by the scanning device through an advertising physical channel.

The scanning procedure may be used while being connected to other BLE device in the BLE piconet.

If the scanning device is in an initiator mode in which the scanning device may receive an advertising event and initiates a connection request. The scanning device may transmit a connection request to the advertising device through the advertising physical channel to start a Bluetooth connection with the advertising device.

When the scanning device transmits a connection request to the advertising device, the scanning device stops the initiator mode scanning for additional broadcast and enters the connected mode.

Discovering Procedure

Devices available for Bluetooth communication (hereinafter, referred to as “Bluetooth devices”) perform an advertising procedure and a scanning procedure in order to discover devices located nearby or in order to be discovered by other devices within a given area.

The discovering procedure is performed asymmetrically. A Bluetooth device intending to discover other device nearby is termed a discovering device, and listens to discover devices advertising an advertising event that may be scanned. A Bluetooth device which may be discovered by other device and available to be used is termed a discoverable device and positively broadcasts an advertising event such that it may be scanned by other device through an advertising (broadcast) physical channel.

Both the discovering device and the discoverable device may have already been connected with other Bluetooth devices in a piconet.

Connecting Procedure

A connecting procedure is asymmetrical, and requests that, while a specific Bluetooth device is performing an advertising procedure, another Bluetooth device should perform a scanning procedure.

That is, an advertising procedure may be aimed, and as a result, only one device may response to the advertising. After a connectable advertising event is received from an advertising device, a connecting request may be transmitted to the advertising device through an advertising (broadcast) physical channel to initiate connection.

Hereinafter, operational states, that is, an advertising state, a scanning state, an initiating state, and a connection state, in the BLE technology will be briefly described.

Advertising State

A link layer (LL) enters an advertising state according to an instruction from a host (stack). In a case in which the LL is in the advertising state, the LL transmits an advertising packet data unit (PDU) in advertising events.

Each of the advertising events include at least one advertising PDU, and the advertising PDU is transmitted through an advertising channel index in use. After the advertising PDU is transmitted through an advertising channel index in use, the advertising event may be terminated, or in a case in which the advertising device may need to secure a space for performing other function, the advertising event may be terminated earlier.

Scanning State

The LL enters the scanning state according to an instruction from the host (stack). In the scanning state, the LL listens to advertising channel indices.

The scanning state includes two types: passive scanning and active scanning. Each of the scanning types is determined by the host.

Time for performing scanning or an advertising channel index are not defined.

During the scanning state, the LL listens to an advertising channel index in a scan window duration. A scan interval is defined as an interval between start points of two continuous scan windows.

When there is no collision in scheduling, the LL should listen in order to complete all the scan intervals of the scan window as instructed by the host. In each scan window, the LL should scan other advertising channel index. The LL uses every available advertising channel index.

In the passive scanning, the LL only receives packets and cannot transmit any packet.

In the active scanning, the LL performs listening in order to be relied on an advertising PDU type for requesting advertising PDUs and advertising device-related additional information from the advertising device.

Initiating State

The LL enters the initiating state according to an instruction from the host (stack).

When the LL is in the initiating state, the LL performs listening on advertising channel indices.

During the initiating state, the LL listens to an advertising channel index during the scan window interval.

Connection State

When the device performing a connection state, that is, when the initiating device transmits a CONNECT_REQ PDU to the advertising device or when the advertising device receives a CONNECT_REQ PDU from the initiating device, the LL enters a connection state.

It is considered that a connection is generated after the LL enters the connection state. However, it is not necessary to consider that the connection should be established at a point in time at which the LL enters the connection state. The only difference between a newly generated connection and an already established connection is a LL connection supervision timeout value.

When two devices are connected, the two devices play different roles.

An LL serving as a master is termed a master, and an LL serving as a slave is termed a slave. The master adjusts a timing of a connecting event, and the connecting event refers to a point in time at which the master and the slave are synchronized.

Hereinafter, packets defined in an Bluetooth interface will be briefly described. BLE devices use packets defined as follows.

Packet Format

The LL has only one packet format used for both an advertising channel packet and a data channel packet.

Each packet includes four fields of a preamble, an access address, a PDU, and a CRC.

When one packet is transmitted in an advertising physical channel, the PDU may be an advertising channel PDU, and when one packet is transmitted in a data physical channel, the PDU may be a data channel PDU.

Advertising Channel PDU

An advertising channel PDU has a 16-bit header and payload having various sizes.

A PDU type field of the advertising channel PDU included in the heater indicates PDU types defined in Table 1 below.

TABLE 1

| PDU Type | Packet Name |
|---|---|
| 0000 | ADV_IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

Advertising PDU

The following advertising channel PDU types are termed advertising PDUs and used in a specific event.

ADV_IND: Connectable undirected advertising event

ADV_DIRECT_IND: Connectable directed advertising event

ADV_NONCONN_IND: Unconnectable undirected advertising event

ADVSCAN_IND: Scannable undirected advertising event

The PDUs are transmitted from the LL in an advertising state, and received by the LL in a scanning state or in an initiating state.

Scanning PDU

The following advertising channel DPU types are termed scanning PDUs and are used in a state described hereinafter.

SCAN_REQ: Transmitted by the LL in a scanning state and received by the LL in an advertising state.

SCAN_RSP: Transmitted by the LL in the advertising state and received by the LL in the scanning state.

Initiating PDU

The following advertising channel PDU type is termed an initiating PDU.

CONNECT_REQ: Transmitted by the LL in the initiating state and received by the LL in the advertising state.

Data Channel PDU

The data channel PDU may include a message integrity check (MIC) field having a 16-bit header and payload having various sizes.

The procedures, states, and packet formats in the BLE technology discussed above may be applied to perform the methods proposed in this disclosure.

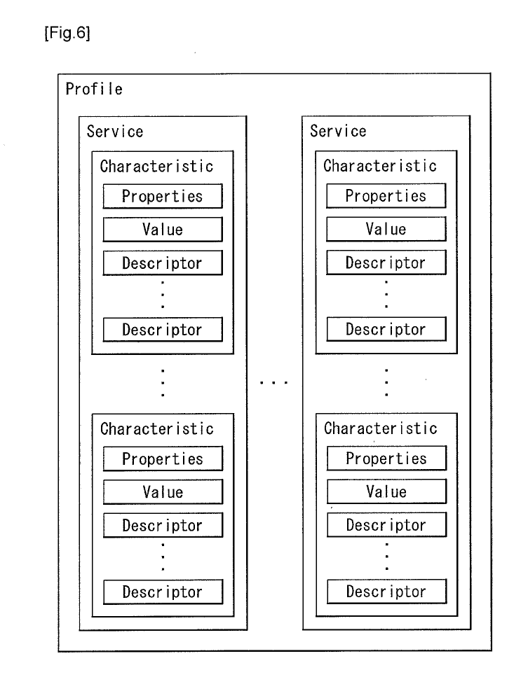

FIG. 6 is a view illustrating an example of a structure of a generic attribute profile (GATT) of Bluetooth low energy.

Referring to FIG. 6, a structure for exchanging profile data of Bluetooth low energy may be looked through.

In detail, the GATT defines a method for exchanging data using a service between Bluetooth LE devices and a characteristic.

In general, a peripheral device (for example, a sensor device) serves as a GATT server, and has definition regarding a service and a characteristic.

In order to read or write data, a GATT client sends a data request to the GATT server, and every operation (transaction) is started by the GATT client and a response is received from the GATT server.

A GATT-based operational structure used in the Bluetooth LE may be a vertical structure as illustrated in FIG. 6 on the basis of a profile, a service, and a characteristic.

The profile includes one or more services, and the services may include one or more characteristics or other services.

The service serves to divide data into logical units and may include one or more characteristics or other services, each of the services has a 16-bit or 128-bit identifier called a universal unique identifier (UUID)).

The characteristic is the lowermost unit in the GATT-based operational structure. The characteristic includes only one data, and has a 16-bit or 128-bit UUID, similar to the service.

The characteristic is defined by values of various types of information, and in order to hold each information, an attribute may be required for each information. The characteristic may use several continuous attributes.

The attribute has four components and has meanings as follows.
handle: Address of attribute
Type: Type of attribute
Value: Value of attribute
Permission: Right to access attribute

The present invention proposes a method in which a sensor measures and stores human activities by using a GATT-based operational structure of the Bluetooth LE, and a client retrieves the stored information from the sensor.

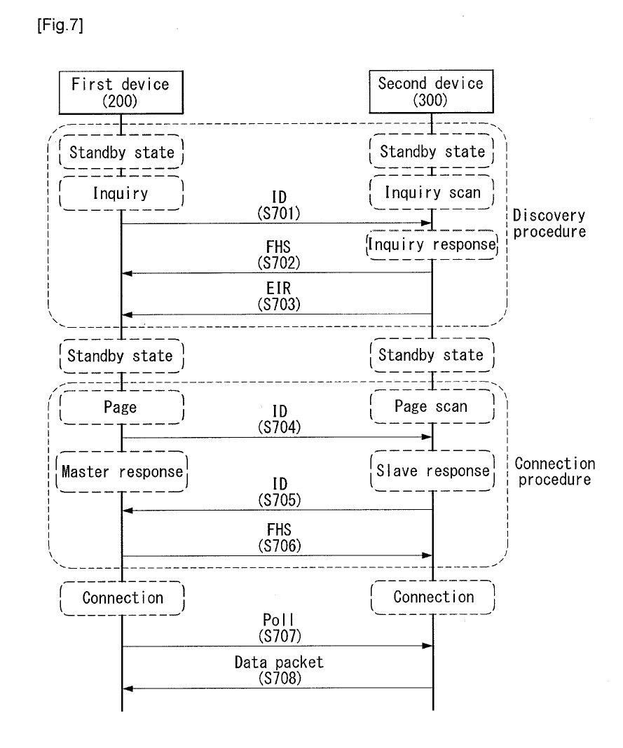

FIG. 7 is a diagram showing a discovery and connection procedure using the Bluetooth BR/EDR.

Discovery Procedure

A first device 200 and a second device 300 remain in a standby state. For Bluetooth BR/EDR discovery, the first device 200 becomes an inquiry state, and the second device 300 becomes an inquiry scan state.

The first device 200 in the inquiry state sends an ID packet so as to perform a Bluetooth BR/EDR discovery procedure (S701). The first device 200 receives a frequency hop synchronization (FHS) packet from the second device 300 as a response to the ID packet (S702).

If the second device 300 attempts to send additional information about the second device 300, it may send the additional information to the first device 200 using an enhanced inquiry packet (EIR) (S703).

If the first device 200 that has checked the presence of another device and information about another device through such a discovery procedure attempts to connect to the second device 300, it performs a paging procedure.

Paging Procedure

In the paging procedure, the first device 200 enters a page state, and the second device 300 enters a page scan state.

The first device 200 in the page state sends an ID packet to the second device 300 (S704).

When the second device 300 receives the ID packet transmitted by the first device, the first device 200 enters the BR/EDR master response state of the BR/EDR page state, and the second device 300 enters the BR/EDR slave state of the BR/EDR page state.

Thereafter, the first device 200 sends a second ID packet in a channel in which the ID packet has been transmitted (S705).

The second device 300 that has received the second ID packet sends a frequency hopping synchronization (FHS) packet to the first device 200 for frequency synchronization (S706).

When the paging procedure is completed, the first device 200 and the second device 300 switch to a BR/EDR connection state.

Thereafter, the second device 300 switches to the hopping pattern of the first device 200. In order to check such switching, the first device 200 sends a Poll packet to the second device 300 (S707). The second device 300 that has received the Poll packet sends a data packet to the first device 200 as a response to the Poll packet (S708). Accordingly, the Bluetooth BR/EDR connection procedure is terminated.

Such a procedure is performed when devices attempt to perform wireless communication through the Bluetooth BR/EDR. Such a procedure has problems in that whether the first device and the second device support the Bluetooth BR/EDR must be previously checked and that a required service can be used only when a Bluetooth BR/EDR connection is formed and communication is performed using the Bluetooth BR/EDR.

Furthermore, the Bluetooth BR/EDR has a disadvantage in that the time for Bluetooth LE versus device discovery is long and power consumption is great.

Accordingly, in order to solve the problems, an embodiment of the present invention provides a method for rapidly checking whether several devices or a device having a designated device address supports the Bluetooth BR/EDR through the Bluetooth LE and that the several devices or the device can provide which service with low power and performing a Bluetooth BR/EDR connection.

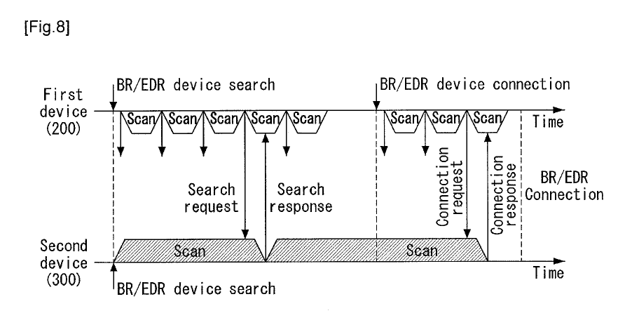

FIG. 8 is a diagram showing a discovery and connection procedure using the Bluetooth BR/EDR.

The discovery and connection procedure using the Bluetooth BR/EDR, described with reference to FIG. 7, is described in brief below with reference to FIG. 8.

More specifically, the first device 200 functions to request discovery, receive a response, and notify a user of surrounding device information and to make a connection request. The second device 300 functions to respond to a discovery request and to respond to a connection request.

In this case, the second device 300 has to continue to maintain a scan state because it is unaware when the discovery request and connection request of the first device 200 are generated.

There is a problem in that the second device 300 consumes great power in such a process.

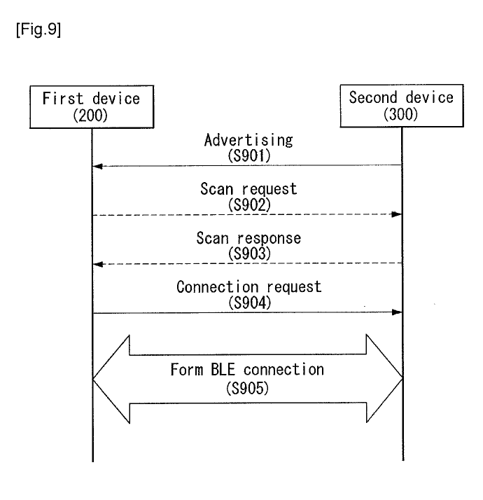

FIG. 9 is a diagram showing a discovery and connection procedure using the Bluetooth LE.

Referring to FIG. 9, a second device 300 may notify surrounding devices of the second device by sending an advertising message to the surrounding devices using the aforementioned three advertising channels (S901).

At this time, the second device 300 sends the advertising message by hopping the three advertising channels at its time intervals.

A first device 200 that has received the advertising message from the second device 300 may discover the second device 300. If the first device 200 wants to request additional information, it sends a scan request message to the second device 300 (S902).

The second device 300 sends a scan response message, including the additional information, to the first device 200 in response to the scan request message (S903).

If the first device 200 wants to form a Bluetooth LE connection with the second device 300, it sends a connection request message to the second device 300 (S904), and forms the Bluetooth LE connection through the synchronization of timing information with the second device (S905).

An embodiment of the present invention proposes a method capable of reducing power consumption by forming a Bluetooth BR/EDR connection through a process of forming a Bluetooth LE connection and a Bluetooth LE connection.

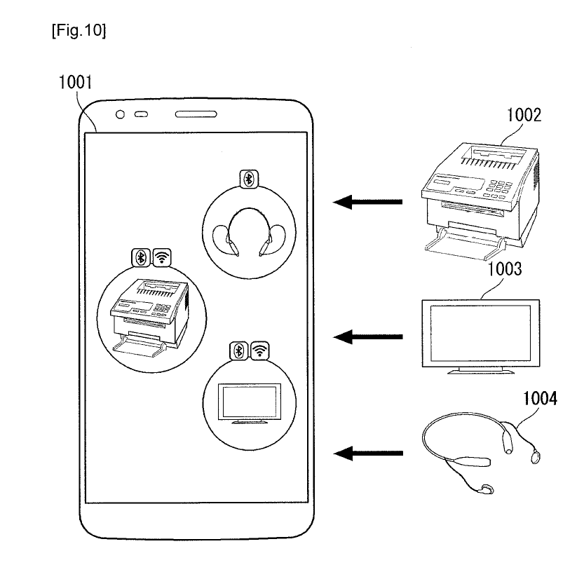

FIG. 10 is a diagram for illustrating a problem occurring in a device discovery method using existing Bluetooth communication.

Referring to FIG. 10, a user may search for devices 1002, 1003, and 1004 using Bluetooth communication using a smart phone 1001.

The smart phone 1001 may search for the devices 1002, 1003, and 1004 by scanning advertising packets transmitted by the devices 1002, 1003, and 1004, and may be aware of a public device address, device information, and service information based on the retrieved results.

The public device address (or public address) is the name of a device, and may be searched for through the user interface (UI) of another Bluetooth device.

That is, all of devices (or controllers) may search for a Bluetooth device by scanning an advertising message and may be aware of human-readable information including a device public address, device information, and service information.

If a device supporting several services sends human-readable information (e.g., a device name, a device type, and a device icon) to another device through an advertising packet or a GATT protocol, a third party may identify adjacent devices easily or intuitively.

There is no way to provide Secure and Privacy-enabled Advertising for only allowed users can scan and discover nearby privacy-enabled devices.

Furthermore, hackers may make bad use of device information which may be recognized from an advertising packet.

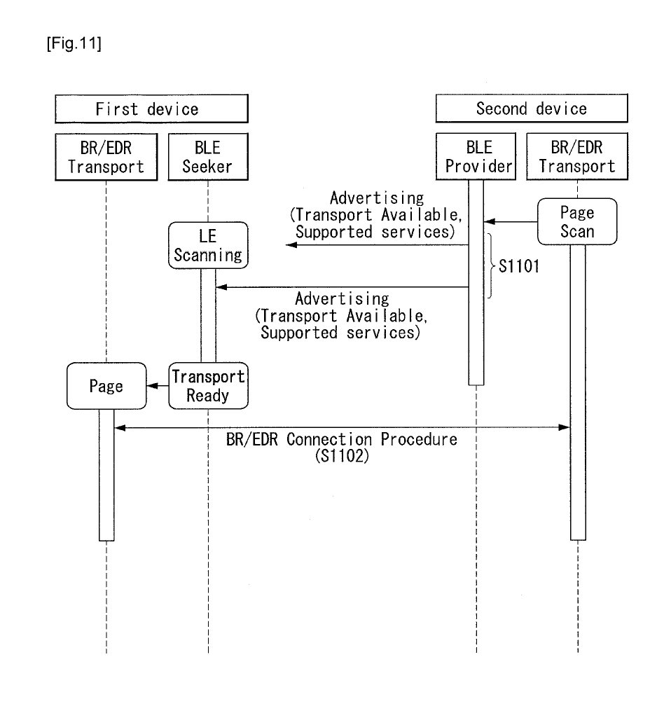

FIG. 11 is a diagram schematically showing a Bluetooth BR/EDR connection procedure through the Bluetooth LE.

Referring to FIG. 11, a Bluetooth BR/EDR connection procedure using the existing Bluetooth LE may be divided into a discovery procedure through LE and a connection procedure through BR/EDR.

If there is a discovery request from a user, the seeker of a first device receives an advertising packet, transmitted by the provider of a second device, through a scanning process (S1101).

The advertising packet may include information about whether alternative communication means is available and information about supported services.

That is, a discovery procedure using LE is performed through step S1101. After whether another device is present or not and information about another device are checked through the discovery procedure, the first device may send a request message for performing a BR/EDR connection through a BLE interface.

When a request for a BR/EDR connection from the user is present, the first device and the second device performs a BR/EDR connection procedure (S1102).

In this case, the BR/EDR connection procedure may be performed according to the method described with reference to FIG. 7.

In such a method, an unnecessary procedure is performed because a discovery procedure is performed again in a Bluetooth BR/EDR procedure along with the same device although a Bluetooth LE connection has already been completed, and the time and power are wasted due to the execution of the unnecessary procedure.

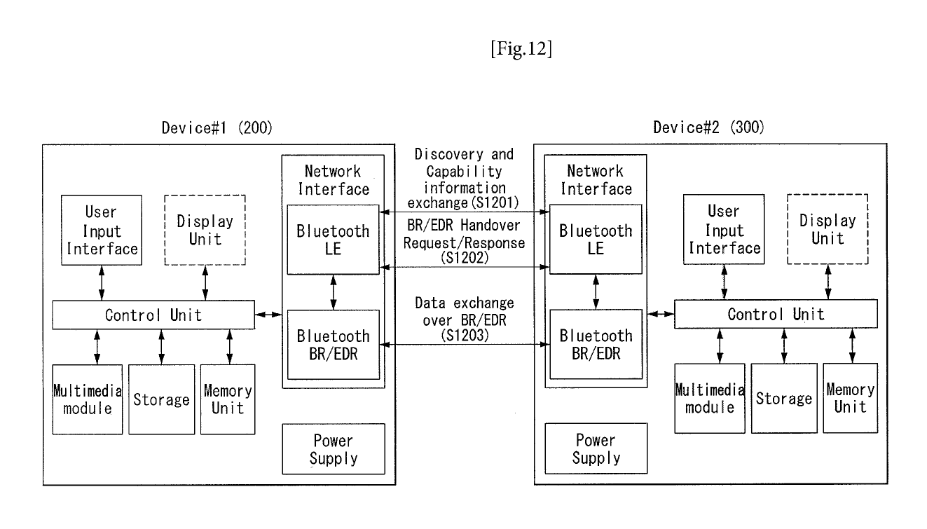

FIG. 12 is a diagram showing an example in which a message is transmitted and received between network interfaces for connecting alternative communication means through the Bluetooth LE to which an embodiment of the present invention may be applied.

Referring to FIG. 12, a first device 200 and a second device 300 may discover a counterpart device through a Bluetooth LE interface for low power wireless communication, may exchange pieces of capability information, may connect Bluetooth BR/EDR interfaces through the exchanged capability information, and may exchange data.

More specifically, the first device 200 may discover the second device 300 through the Bluetooth LE and may exchange capability information with the second device (S1201).

The capability information may include alternative communication technology information (e.g., Bluetooth BR/EDR, Wi-Fi, Wi-Fi Direct, and NFC) supported by each device and service list information indicating services which may be provided through each alternative communication technology.

If the first device 200 and the second device 300 that have exchanged the capability information want to perform a Bluetooth BR/EDR connection, the first device 200 may send a handover request message that requests a BR/EDR connection to the second device 300 through the Bluetooth LE. The second device 300 may send a handover response message to the first device 200 in response to the handover request message (S1202).

Thereafter, the first device 200 and the second device 300 connected through the Bluetooth BR/EDR may exchange data through the Bluetooth BR/EDR (S1203).

A Bluetooth BR/EDR connection may be performed using Bluetooth LE having high energy efficiency through such a method.

In contrast, the first device 200 and the second device 300 may send and receive a handover request message/handover response message that request a Bluetooth LE connection through Bluetooth BR/EDR interfaces in a BR/EDR connection state.

Thereafter, the first device 200 and the second device 300 connected through the Bluetooth LE may exchange data through the Bluetooth LE.

As described with reference to FIG. 8, in accordance with the discovery and connection procedure using the existing BR/EDR, in order to receive a discovery request and a connection request, a scanner device has to continue to maintain a scan state. Great power may be consumed in such a process.

Furthermore, as described above, in a BR/EDR connection method through the existing Bluetooth LE, an unnecessary procedure is performed because a discovery procedure is performed again in a Bluetooth BR/EDR procedure along with the same device although a Bluetooth LE connection has already been completed, and the time and power are consumed due to the execution of the unnecessary procedure.

Furthermore, as described above, the existing Bluetooth communication method has a problem in that it is difficult to protect personal information and maintain security because all of devices using Bluetooth communication can search for a device.

Accordingly, in order to solve the problem, an embodiment of the present invention provides a method for checking whether each device supports a Bluetooth BR/EDR through Bluetooth LE and can provide which service and performing a Bluetooth BR/EDR connection.

Furthermore, in order to solve the problem, an embodiment of the present invention proposes a method for minimizing power necessary for device discovery using Bluetooth LE.

Furthermore, an embodiment of the present invention proposes an advertising method using a target address in order to enhance privacy.

In this case, the target address means the address of a specific device to be discovered or connected, but the name thereof is not limited thereto. The target address may be called various names, such as a seeker address, a provider address, or a destination address.

For example, the address of a specific device or the address of a bonded device intended by a user may be used as a target address (or a seeker address).

That is, a target address may be set by inserting the address of a specific device, intended by a user, into an advertising packet.

Furthermore, when two devices perform a Bluetooth bonding procedure, the security key and device address of a counterpart device can be obtained between the two devices. As described above, a target address may be set by inserting the address of a bonded device into an advertising packet.

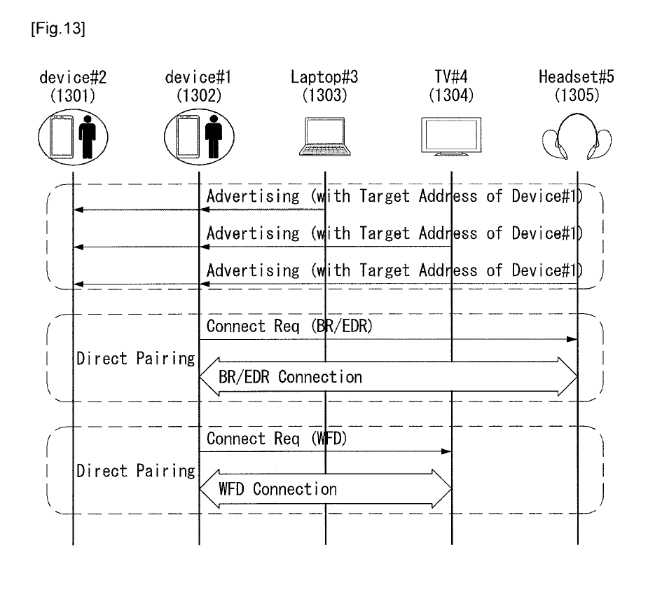

FIG. 13 is an embodiment to which the present invention may be applied and is a diagram for illustrating an advertising method for connecting alternative communication means through Bluetooth LE.

In FIG. 13, it is assumed that a laptop 1303, TV 1304, and a headset 1305 have been bonded to a first device 1302.

The laptop 1303, the TV 1304 or the headset 1305 may broadcast advertising (or an advertising event) through an advertising physical channel within an area. In this case, the laptop 1303, the TV 1304 or the headset 1305 may broadcast the advertising (or advertising event) in which the address of a device bonded to the advertising has been set as a target address.

By inserting the address of the first device, that is, a bonded device, into the advertising, only the first device may be allowed to perform discovery and connection.

In contrast, a second device does not process an advertising packet transmitted by the laptop 1303, the TV 1304 or the headset 1305 because the address of the first device other than the second device is the target address.

If a provider, such as the laptop 1303, the TV 1304 or the headset 1305, designates a target address (e.g., 45:76:54:AA:44:11) and broadcasts advertising, the seeker of the target address may directly send a connection request and form a Bluetooth connection with the provider.

The protection of personal information can be enhanced because only a bonded device is allowed for discovery and connection.

Furthermore, a bonded device or a dedicated device may be searched for using Bluetooth LE, and handover may be performed between heterogeneous networks.

For example, a bonded device may be searched for using Bluetooth LE, and a Bluetooth BR/EDR connection may be performed through the Bluetooth LE.

That is, the first device 1302 may search for the headset 1305 through advertising using the first device 1302 as a target address, and may form a BR/EDR connection with the headset 1305 by directly making a BR/EDR connection request.

Alternatively, after searching for the headset 1305 through advertising using the first device 1302 as a target address, the first device 1302 may form an LE connection with the headset 1305, may check whether Bluetooth BR/EDR is supported, and may request service information. Thereafter, the first device 1302 may make a BR/EDR connection request from the headset 1305, so the BR/EDR connection may be formed between the headset 1305 and the first device 1302.

Furthermore, for example, after a bonded device is searched for using Bluetooth LE in a Wi-Fi off state, a Wi-Fi connection with the retrieved device may be performed.

That is, the first device 1302 may search for the TV 1304 through advertising using the first device 1302 as a target address and request a Wi-Fi connection from the TV 1304, so the Wi-Fi connection may be formed between the TV 1304 and the first device 1302.

Power necessary for search can be minimized by searching for a low power device and a service using Bluetooth LE. More specifically, power of ¼ compared to BR/EDR can be consumed and power of 1/10 compared to Wi-Fi can be consumed using BLE.

Furthermore, the state of surrounding devices can be immediately (i.e., within 1 second) checked by always performing device discovery using BLE.

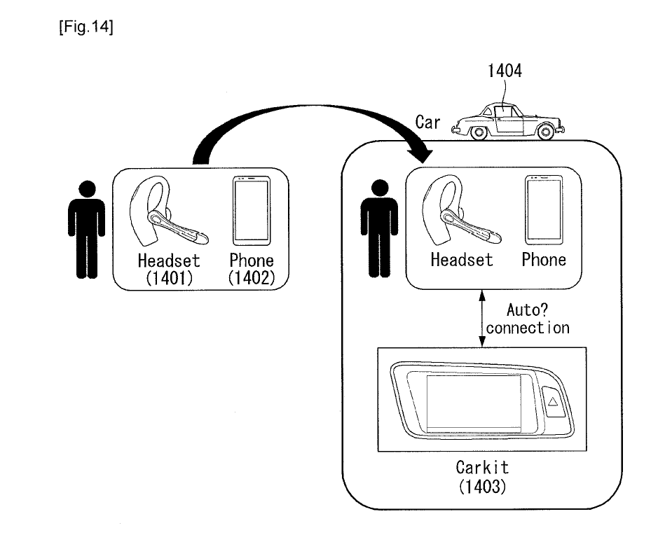

FIG. 14 is an embodiment to which the present invention may be applied and is a diagram for illustrating a method for connecting to a device set as a target address.

In FIG. 14, it is assumed that a headset 1401 and a smart phone 1402 are used as a user device using Bluetooth communication.

The headset 1401 and the smart phone 1402 may be bonded devices which have exchanged security keys with a car kit 1403 through a Bluetooth bonding procedure. Furthermore, the car kit 1403 may be the dedicated provider of the headset 1401 and the smart phone 1402 for a reason, such as that the addresses of the headset 1401 and the smart phone 1402 have been previously set in the car kit 1403.

When a user carries the headset 1401 or the smart phone 1402 and rides in a vehicle 1404, the car kit 1403 may advertise using the headset 1401 or the smart phone 1402 as a target address.

In this case, the car kit 1403 may perform a BR/EDR connection through a BR/EDR handover request after an LE connection with the headset 1401 or the smart phone 1402, or may perform a BR/EDR connection after checking whether BR/EDR is supported or not or exchanging service information without an LE connection.

Transport discovery service (TDS) advertising to which a target address has been attached may be used to allow a provider to connect to a bonded seeker or a specific seeker or to allow a seeker to attempt a new connection with a dedicated provider without the intervention of a user or through only a simple selection process by a user.

A bonded device set as a target address or the device of a specific address may respond to advertising whose target is the bonded device.

When a seeker receives TDS advertising to which a target address has been attached from a provider, the seeker may request a connection from the provider because the TDS advertising may be considered to be direct advertising for a new connection with the seeker.

In this case, a connection between the seeker and the provider may be formed at the same time when the seeker requests the connection.

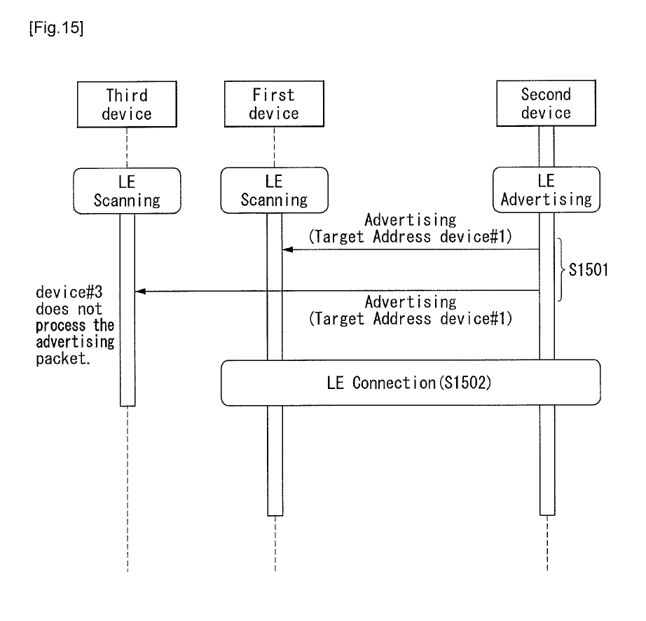

FIG. 15 is an embodiment to which the present invention may be applied and is a diagram showing a method for connecting to a device having a target address by sending an advertising message into which the target address has been inserted.

A second device sends an advertising message in which a first device has been set as a target address to the first device and a third device (S1501).

In this case, the second device may broadcast the advertising packet into which the target address has been inserted through an advertising physical channel.

The third device not set as the target address does not process the received advertising packet.

A Bluetooth LE connection is formed between the first device and the second device (S1502).

The first device set as the target address may be connected to the second device based on the received advertising packet. In this case, the first device may send a connection request message to the second device, if necessary.

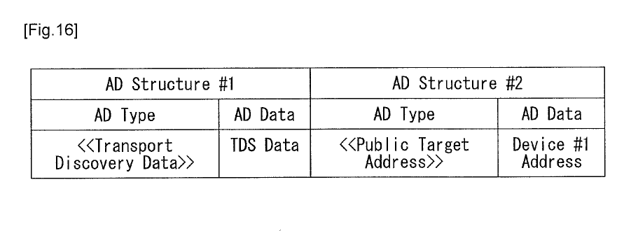

FIG. 16 is an embodiment to which the present invention may be applied and is a diagram illustrating an advertising packet including a target address field.

As shown in FIG. 16, the advertising packet may include transport discovery service (TDS) data and a target address.

That is, information related to a supported heterogeneous network and information related to a target address to be connected/discovered may be transmitted through an advertising packet. If an AD type field indicates transport discovery data, TDS Data may be included in an AD Data field. If the AD type field indicates a public target address, the address of a first device, that is, a target address, may be included in the AD Data field.

In this case, if one or more devices have been bonded together using the public target address, the public target address indicates the address of one or more recipient devices intended in an advertising procedure.

In contrast, although an AD type field indicates a random target address, the random address of a first device, that is, a target address, may be included in an AD Data field.

In this case, if one or more devices have been bonded together using the random address, the random target address indicates the address of the one or more recipient devices intended in the advertising procedure.

The random address is the address of a device between devices that have previously performed a connection procedure. The random address indicates the address of a device that has been generated by sharing a specific seed value between two devices and using the shared seed value. In other words, the random address indicates a resolvable private address which can be recognized by only the two devices.

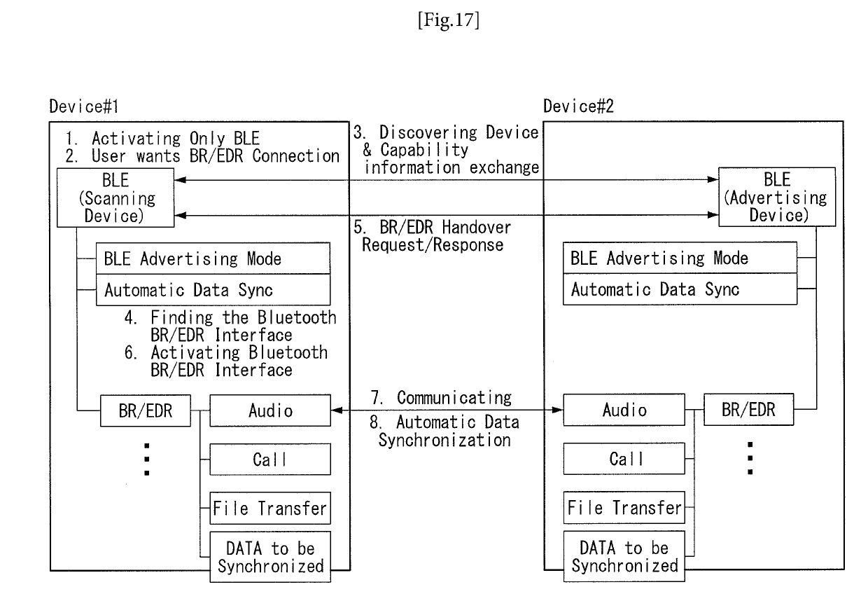

FIG. 17 is an embodiment to which the present invention may be applied and is a diagram showing an example of a Bluetooth BR/EDR connection mechanism using the Bluetooth LE.

1. A first device and a second device activate BLE communication in the state in which BR/EDR is a sleep state.

2. The first device receives a BR/EDR connection request from a user. In this case, the user may select a service provided by BR/EDR. For example, the user may indicate that an audio transmission service of serviced provided by the BR/EDR is performed.

3. The first device and the second device discover a counterpart device using Bluetooth LE and exchange capability information.

In this case, the capability information may include alternative communication technology information (e.g., Bluetooth BR/EDR, Wi-Fi, Wi-Fi Direct and/or NFC) supported by each device and service list information indicating services which may be provided through each alternative communication technology.

4. The first device and the second device search for Bluetooth BR/EDR interfaces.

5. The first device and the second device transmit and receive a BR/EDR handover request/response based on the capability information.

6. The first device and the second device activate the BR/EDR interfaces.

7. The first device and the second device perform a BR/EDR connection.

8. The first device and the second device perform a service requested by a user through BR/EDR. For example, the first device and the second device may transmit and receive data to be synchronized (e.g., a recent user telephone number, SMS, navigator destination information or audio data) through the BR/EDR.

A connection with alternative communication means through Bluetooth LE between bonded devices or specific devices may be performed in various manners. Embodiments applicable to such a connection are described below.

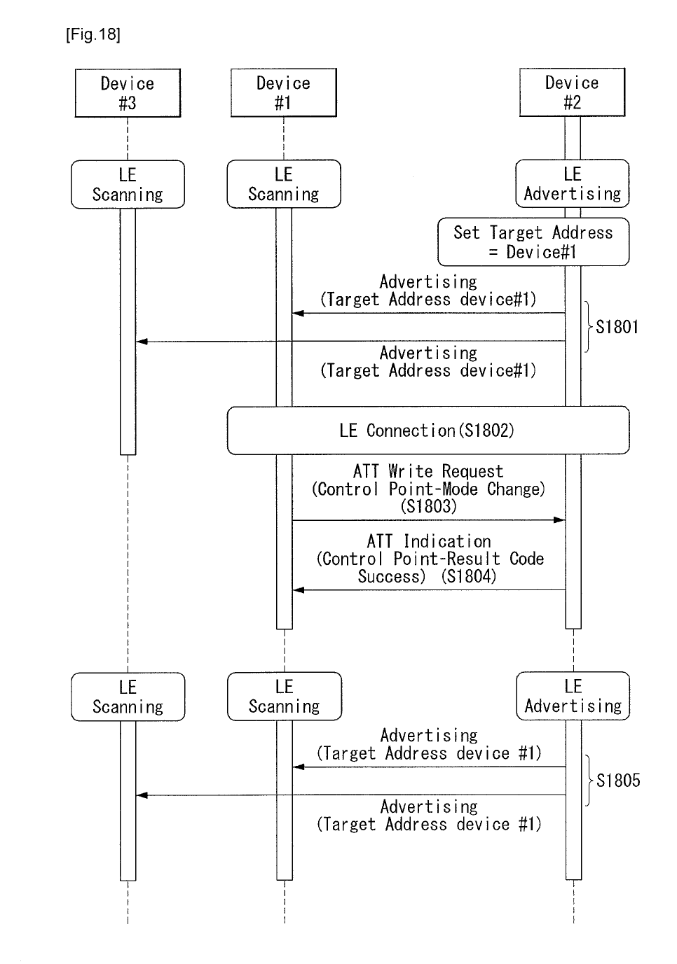

FIG. 18 is an embodiment to which the present invention may be applied and is a diagram showing a method for performing a Bluetooth BR/EDR connection using the Bluetooth LE.

In FIG. 18, it is assumed that a first device (or a BLE seeker) has been set as a target address in a second device (i.e., a BLE provider).

The second device sends an advertising message in which the first device has been set as the target address to the first device and a third device (S1801).

The second device may be in a target address mode. In this case, the target address mode refers to the state in which a target address has been set and an advertising message is transmitted or received.

That is, in the target address mode in which the first device has been set as the target address, the second device may send the advertising message, including the target address, to the first device or the third device.

In this case, the advertising message may be transmitted to the first device and the third device in a broadcast manner through an advertising physical channel. Furthermore, the second device may send the advertising message including all of permitted AD types.

The third device does not process the advertising message because the received advertising message includes the first device, that is, a different device, as the target address.

As described above, advertising in the target address mode may be transmitted by a provider if a bonded device or a specific device is searched for.

Since a target address is set, a device not set as a target address can be prevented from unnecessarily responding to an advertising message transmitted toward a different device.

Furthermore, since a target address is set, a provider can efficiently bootstrap a specific peer.

The first device forms a Bluetooth LE connection with the second device (S1802).

The first device may form the Bluetooth LE connection with the second device based on the advertising message received at step S1801.

As described above, an advertising message in which a target address has been set may be considered to be direct advertising for a connection with the device of the target address. In this case, the first device may send a connection request message to the second device.

The first device and the second device may be connected simultaneously with the connection request of the first device. In this case, prior to step S1802, the first device may send a request message that requests an LE connection to the second device.

The first device sends a write request message, including control information, to the second device in order to indicate the ON of Bluetooth BR/EDR, that is, an alternative communication technology to be connected, and the activation of a service (S1803).

In this case, the first device may request the writing of a “control point” characteristic in order to indicate the ON of Bluetooth BR/EDR (or mode change) and the activation of a service through the write request message.

In this case, the service may include an audio streaming service, a hands-free service and/or a data synchronization (or automatic data synchronization) service, for example.

Furthermore, the control information may include Opcode for indicating a specific operation for the second device and a parameter value therefor.

The first device receives a write response message as a response to the write request message (S1804).

The second device may activate the ON of the Bluetooth BR/EDR, that is, alternative communication means, and the service in response to an instruction from the first device. In this case, the second device may activate only part of or the entire service instructed by the first device.

At steps S1803 and S1804, the request message and the response message may be transmitted through an advertising channel using Bluetooth LE. In this case, step S1802 may be omitted. In other words, in such a case, the BR/EDR handover request/response may be transmitted and received through an advertising message without the intervention of a BLE connection procedure.

The second device sends an advertising message in which the first device has been set as a target address to the first device and the third device (S1805).

If the Bluetooth BR/EDR connection state through step S1804 is terminated and the first device and the second device are to be connected through Bluetooth BR/EDR, the first device and the second device may enter the Bluetooth BR/EDR connection state by performing step S1801 to step S1804.

Furthermore, the second device may insert a security key, exchanged with the first device through a bonding procedure, into the advertising message. Privacy can be improved by confirming (or authenticating) a previously shared security key in addition to the address of a device.

Furthermore, an automatic connection may be performed simultaneously with search between bonded devices. In this case, the Bluetooth BR/EDR connection may be formed without the intervention of a user.

Furthermore, the second device may switch to a common mode in which a target address has not been set other than a target address mode by taking into consideration the addition of a new device, and may perform an advertising procedure. For example, if there is a request from a use, the second device may broadcast an advertising message in which a target address has not been set. Alternatively, for example, the second device may periodically (or intermittently) switch from the target address mode to the common mode and may perform an advertising procedure.

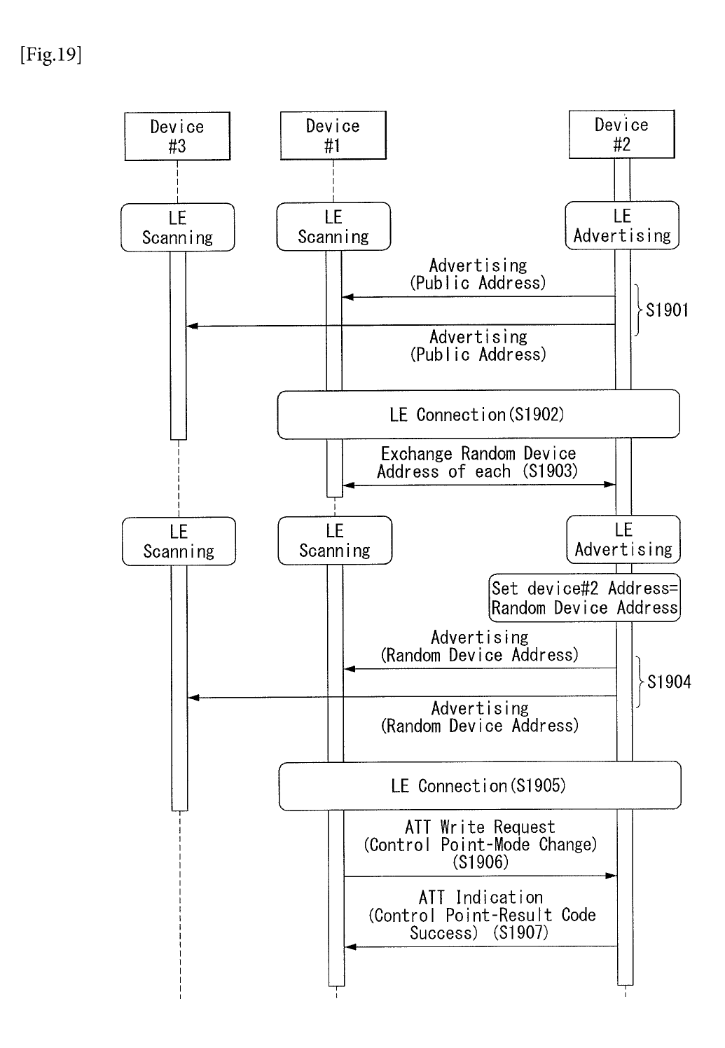

FIG. 19 is an embodiment to which the present invention may be applied and is a diagram showing a method for performing a Bluetooth BR/EDR connection using Bluetooth LE.

Referring to FIG. 19, after step S1901 to step S1903 are performed, a connection state is terminated. It is assumed that at step S1904, a Bluetooth connection is formed between a first device (or provider) and a second device (or seeker) again.

The second device sends an advertising message to the first device and a third device (S1901).

In this case, the second device may insert the public address of the second device into the advertising message and send the advertising message.

The first device forms a Bluetooth LE connection with the second device (S1902).

The first device may form the Bluetooth LE connection with the second device based on the advertising message received at step S1901. In this case, the first device may form a BLE connection with the second device in accordance with the method described with reference to FIG. 9.

The first device and the second device send and receive the address of a random device (S1903).

The first device and the second device may share a specific seed value and generate the address of the random device using the shared seed value. The random address may be generated as a value which can be recognized by only the first device and the second device.

The second device sends an advertising message, including the address of the random device, to the first device and the third device (S1904).

The second device in the advertising state may set its own address as the address of the random device generated at step S1903, and may send the advertising message, including the address of the random device, to the first device and the third device.

In this case, the first device may recognize that the address of the random device is the address of the second device. In contrast, the third device cannot recognize the address of the second device using the address of the random device because it has not shared the address of the random device with the second device.

Accordingly, the third device may not process the advertising message because it cannot recognize the address of the second device based on the received advertising message.

The first device forms a Bluetooth LE connection with the second device (S1905).

The first device may form the Bluetooth LE connection with the second device based on the advertising message received at step S1904.

An advertising message in which a random device has been set and which can be recognized by a counterpart device may be considered to be direct advertising for a connection with the counterpart device. In this case, the first device may send a connection request message to the second device.

The first device and the second device may be connected simultaneously with the connection request of the first device. In this case, prior to S1902, the first device may send a request message that requests the Bluetooth LE connection to the second device.

The first device sends a write request message, including control information, in order to indicate the ON of Bluetooth BR/EDR, that is, an alternative communication technology to be connected, and the activation of a service, to the second device (S1906).

In this case, the first device may request the writing of a “control point” characteristic in order to indicate the ON of the Bluetooth BR/EDR (or mode change) and the activation of the service through the write request message.

Furthermore, the control information may include Opcode for indicating a specific operation for the second device and a parameter value therefor.

The first device receives a write response message as a response to the write request message (S1907).

The second device may activate the ON of the Bluetooth BR/EDR, that is, alternative communication means, and the service in response to an instruction from the first device. In this case, the second device may activate only part of or the entire service instructed by the first device.

Furthermore, the second device may perform an advertising procedure without setting the address of a random device by taking into consideration the addition of a new device. For example, if there is a request from a user, the second device may broadcast an advertising message in which the address of a random device has not been set. Alternatively, for example, the second device may periodically (or intermittently) perform an advertising procedure without setting the address of a random device.

At step S1906 and step S1907, the request message and the response message may be transmitted through an advertising channel using Bluetooth LE. In this case, step S1905 may be omitted. In other words, in such a case, a BLE connection procedure is not performed, and a BR/EDR handover request/response may be transmitted and received as an advertising message.

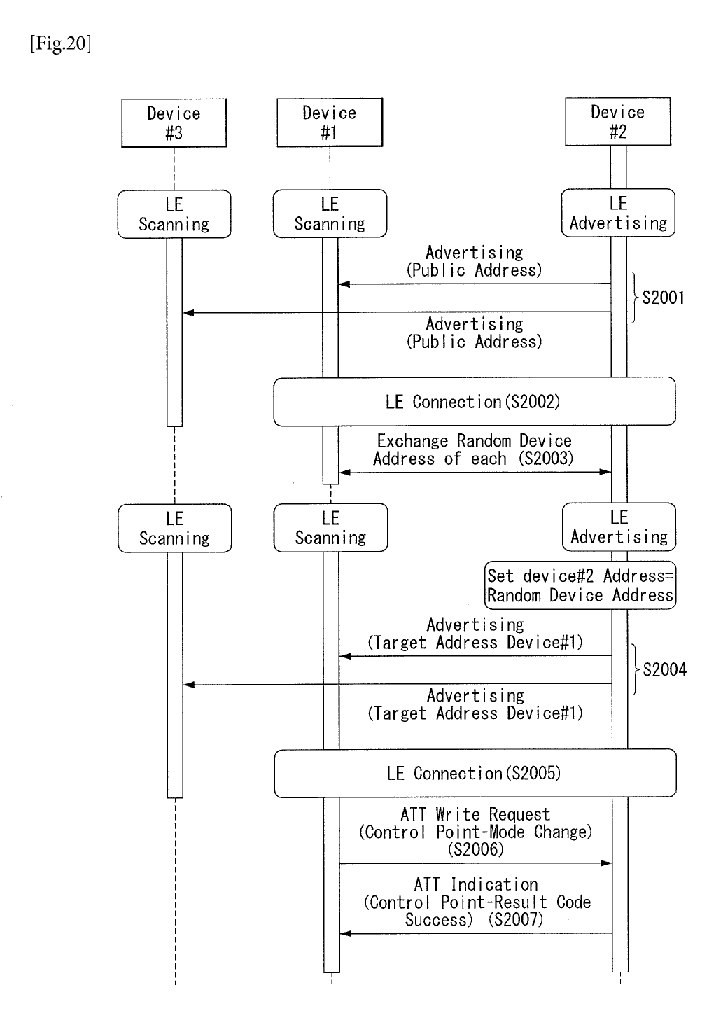

Furthermore, the two embodiments described with reference to FIGS. 18 and 19 may be independently applied or may be combined and applied. This is described below with reference to FIG. 20.

FIG. 20 is an embodiment to which the present invention may be applied and is a diagram showing a method for performing a Bluetooth BR/EDR connection using Bluetooth LE.

Referring to FIG. 20, after step S2001 to step S2003 are performed, a connection state is terminated. It is assumed that at step S2004, a Bluetooth connection is formed between a first device (or provider) and a second device (or seeker) again.

The second device sends an advertising message to the first device and a third device (S2001).

In this case, the second device may insert the public address of the second device into the advertising message and send the advertising message.

The first device forms a Bluetooth LE connection with the second device (S2002).

The first device may form the Bluetooth LE connection with the second device based on the advertising message received at step S2001. In this case, the first device may form a BLE connection with the second device in accordance with the method described with reference to FIG. 9.

The first device and the second device send and receive the address of a random device (S2003).

In this case, the first device and the second device may share a specific seed value and generate the address of the random device using the shared seed value. The random address may be generated as a value which can be recognized by only the first device and the second device.

The second device sets the first device as a target address and sends an advertising message, including the address of the random device, that is, the second device, to the first device and the third device (S2004).

That is, the second device in the advertising state may set its own address as the address of the random device generated at step S2003, and may send the advertising message, including the address of the random device, to the first device and the third device.

Furthermore, the second device may insert the first device into the advertising message as the target address and send the advertising message to the first device and the third device. Furthermore, if a device bonded using a random address is set as a target address, the target address may be inserted into an advertising message using the random address of the first device.

In this case, the first device may recognize that the address of the random device is the address of the second device. In contrast, the third device cannot recognize the address of the second device using the address of the random device because it has not shared the address of the random device with the second device.

Accordingly, the third device may not process the advertising message because it cannot recognize the address of the second device based on the received advertising message.

Alternatively, the third device may not process the advertising message because the received advertising message does not include the third device as the target address.

The first device forms a Bluetooth LE connection with the second device (S2005).

The first device may form the Bluetooth LE connection with the second device based on the advertising message received at step S2004.

An advertising message in which a random device has been set and which can be recognized by a counterpart device may be considered to be direct advertising for a connection with the counterpart device. In this case, the first device may send a connection request message to the second device.

Alternatively, the advertising message in which the target address has been set may be considered to be direct advertising for a connection with the device of the target address. In this case, the first device may send a connection request message to the second device.

The first device and the second device may be connected simultaneously with the connection request of the first device. In this case, prior to S2002, the first device may send a request message that requests the Bluetooth LE connection to the second device.

The first device sends a write request message, including control information, in order to indicate the ON of Bluetooth BR/EDR, that is, an alternative communication technology to be connected, and the activation of a service, to the second device (S2006).

In this case, the first device may request the writing of a “control point” characteristic in order to indicate the ON of the Bluetooth BR/EDR (or mode change) and the activation of the service through the write request message.

Furthermore, the control information may include Opcode for indicating a specific operation for the second device and a parameter value therefor.

The first device receives a write response message as a response to the write request message (S2007).

The second device may activate the ON of the Bluetooth BR/EDR, that is, alternative communication means, and the service in response to an instruction from the first device. In this case, the second device may activate only part of or the entire service instructed by the first device.

At step S2006 and step S2007, the request message and the response message may be transmitted through an advertising channel using Bluetooth LE. In this case, step S2005 may be omitted. In other words, in such a case, the BR/EDR handover request/response may be transmitted and received as an advertising message without the intervention of a BLE connection procedure.

Furthermore, the second device may perform an advertising procedure without setting the address of a random device by taking into consideration the addition of a new device. For example, if there is a request from a user, the second device may broadcast an advertising message in which the address of a random device has not been set. Alternatively, for example, the second device may periodically (or intermittently) perform an advertising procedure without setting the address of a random device.

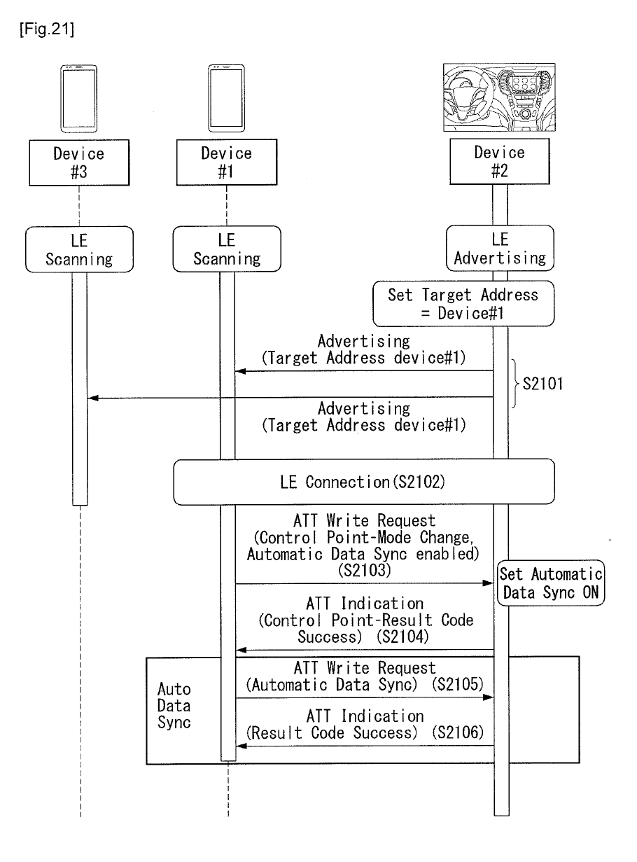

FIG. 21 is an embodiment to which the present invention may be applied and is a diagram showing a method for performing a data synchronization service using the Bluetooth LE.

A second device sends an advertising message in which a first device has been set as a target address to the first device and a third device (S2101).

The second device may be in a target address mode state.

That is, in the target address mode in which the first device has been set as the target address, the second device may send the advertising message, including the target address, to the first device or the third device.

In this case, the advertising message may be transmitted to the first device and the third device in a broadcast manner through an advertising physical channel. Furthermore, the second device may send the advertising message including all of permitted AD types.

The third device does not process the advertising message because the received advertising message uses the first device, that is, a different device, as the target address.

As described above, advertising in the target address mode may be transmitted by a provider who discovers a bonded device or a specific device.

Since a target address is set, a device not set as a target address can be prevented from unnecessarily responding to an advertising message transmitted toward a different device.

Furthermore, since a target address is set, a provider can efficiently bootstrap a specific peer.

Furthermore, the address of a device bonded using a public address or a random address may be used as the target address. In this case, any one of the methods described with reference to FIGS. 18 to 20 may be applied.

The first device forms a Bluetooth LE connection with the second device (S2102).

The first device may form the Bluetooth LE connection with the second device based on the advertising message received at step S2101.

The advertising message in which the target address has been set as described above may be considered to be direct advertising for a connection with the device of the target address. In this case, the first device may send a connection request message to the second device.

The first device and the second device may be connected simultaneously with the connection request of the first device. In this case, prior to step S2102, the first device may send a request message that requests the Bluetooth LE connection to the second device.

The first device sends a first write request message, including control information for indicating the ON of Bluetooth BR/EDR, that is, an alternative communication technology to be connected, and the activation of a data synchronization (or automatic data synchronization) service, to the second device (S2103).

In this case, the first device may request the writing of a “control point” characteristic in order to indicate the ON of the Bluetooth BR/EDR (or mode change) and the activation of the data synchronization service through the write request message.

Furthermore, the control information may include Opcode for indicating a specific operation for the second device and a parameter value therefor. In this case, the control information may include Opcode indicating the activation operation of data synchronization and a parameter value therefor.

The first device receives a first write response message as a response to the write request message (S2104).

The second device may turn on the Bluetooth BR/EDR, that is, alternative communication means, and activate the data synchronization service in response to an instruction from the first device. In this case, the second device may activate only part of or the entire service instructed by the first device.

The first device sends a second write request message, including specific data for performing data synchronization, to the second device (S2105).

That is, if the first device turns on the data synchronization function (or service) of the second device, it may send data by sending the second write request message right after a BLE connection with the second device is formed.

An example in which the first device is a smart phone and the second device is a car kit is described below.

In this case, the data synchronization service may be a service for synchronizing the data of navigators stored in the smart phone and the car kit. Furthermore, the second write request message may include navigation information. For example, the navigation information may be any one of a destination address (or a destination address list) or point of interest (POI) information.

In this case, the POI indicates information regarding a frequently visited area, a nearby restaurant or a large-sized market.

Furthermore, at step S2105, the second write request message may be automatically transmitted by the first device when the data synchronization service is activated through steps S2103 and S2104 although there is no separate instruction or input from a user.

The first device receives a second write response message from the second device as a response to the second write request message (S2106).

The second device may send the response message indicating that data transmitted by the first device has been successfully received.

Furthermore, the second device may send data, stored in the second device, to the first device if the data is necessary for the data synchronization.

After step S2106, the user may execute the navigator system of the car kit and search for a destination address stored in the first device.

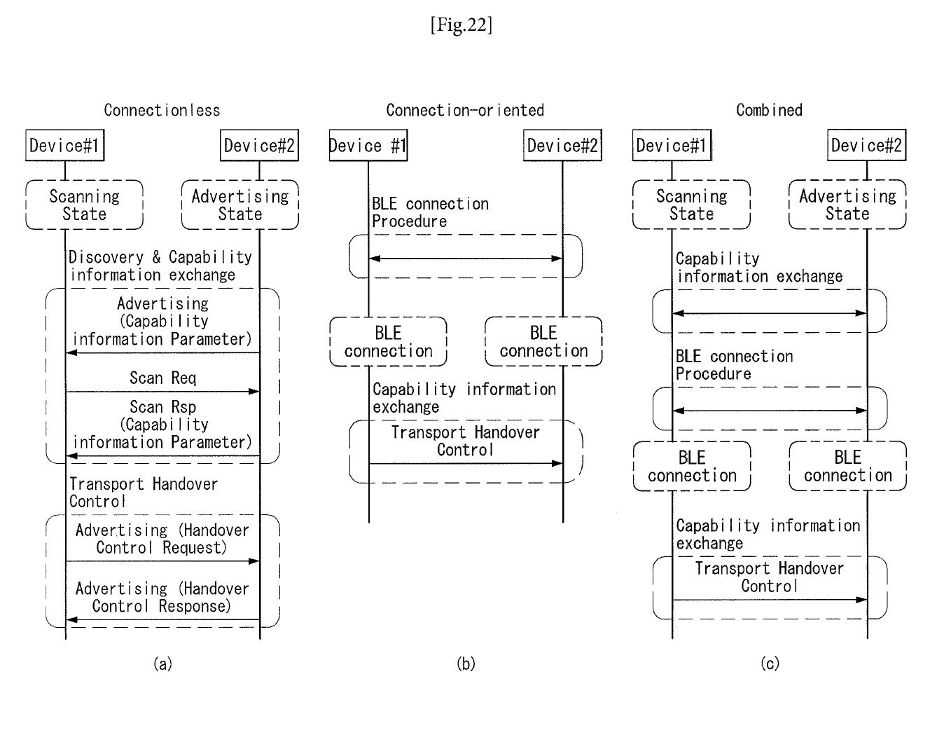

FIG. 22 is an embodiment to which the present invention may be applied and is a diagram for illustrating a BR/EDR information exchange and handover method using the Bluetooth LE.

FIG. 22(a) shows a method for performing a capability information exchange procedure and a BR/EDR handover procedure without a Bluetooth LE connection.

A second device Device #2 sends a first advertising packet including (or inserted) the address of a first device Device #1 as a target address. The first device obtains information about the second device by receiving the first advertising packet.

Furthermore, the first device sends a second advertising packet, including the address of the second device as a target address, to the second device.

In this case, the second advertising packet transmitted by the first device may correspond to a request message that requests a BR/EDR connection. That is, the second device that has received the second advertising packet may send a response message for a handover request to the first device.

In accordance with the method proposed in FIG. 22(a), a BR/EDR connection between devices can be formed by performing a BR/EDR information exchange procedure and a BR/EDR handover procedure through an advertising channel without a BLE connection.

In this case, the discovery (or inquiry) procedure of the BR/EDR connection procedure described with reference to FIG. 7 may be omitted.

A connection procedure can be simplified and power consumed for a BR/EDR connection can be significantly reduced because the BR/EDR connection is formed without a BLE connection after a discovery and capability information exchange procedure is performed through LE.

FIG. 22(b) shows a method for performing a capability information exchange procedure and a BR/EDR handover procedure in a Bluetooth LE connection state.

Referring to FIG. 22(b), first, a first device Device #1 and a second device Device #2 perform a BLE connection procedure.

In this case, a Bluetooth LE connection between the first device and the second device may be formed by applying the method described with reference to FIG. 9.

After the Bluetooth LE connection is formed between the devices, information about BR/EDR interfaces are exchanged, and BR/EDR handover is performed based on the information. Accordingly, security and stability may be high compared to FIG. 22(a).

FIG. 22(c) is a method in which the methods of FIGS. 22(a) and 22(b) are combined. FIG. 22(c) shows a method for exchanging some of capability information parameters before a Bluetooth LE connection is performed, exchanging the remaining capability information in a Bluetooth LE connection state, and performing a BR/EDR handover procedure.

The method of FIG. 22(c) has advantages in that it can provide information exchange in a higher layer, such as the BLE GATT, while maintaining security and stability as in the method of FIG. 22(b).

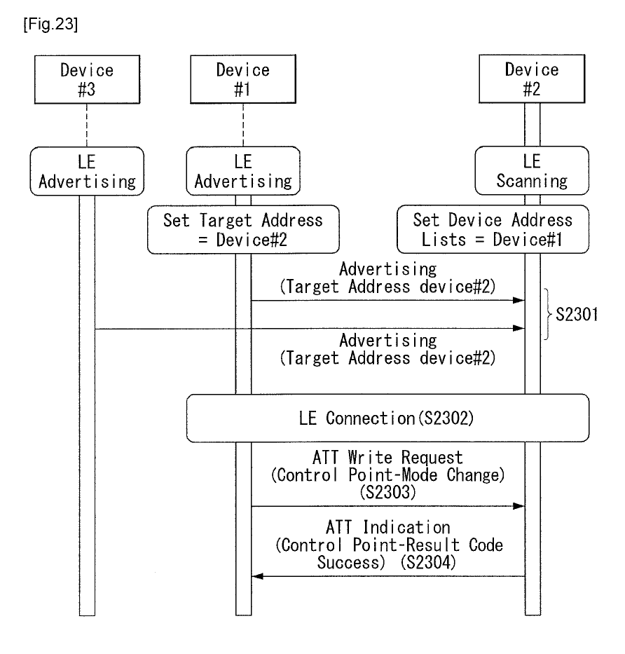

FIG. 23 is an embodiment to which the present invention may be applied and is a diagram showing a method for performing a Bluetooth BR/EDR connection using the Bluetooth LE.

Each of a first device Device #1 and a third device Device #3 sends an advertising message in which a second device Device #2 has been set as a target address to the second device (S2301).

In this case, the first device and the third device may be in a target address mode state.

Furthermore, the second device in a scanning mode may set the first device as a device to be connected or searched for.

That is, in the scanning mode in which the first device has been set as a target address, the second device may receive an advertising message including the second device as a target address.

In this case, the advertising message may be transmitted to the second device in a broadcast manner through an advertising physical channel. Furthermore, each of the first device and the third device may send an advertising message including all of permitted AD types.

Furthermore, the second device may not process the advertising message received from the third device because it is in the scanning mode in which the first device has been set as a target address.

If a bonded device or a specific device is discovered as described above, advertising in the target address mode may be transmitted by a provider or a seeker.

Since a target address is set, a device not set as a target address can be prevented from unnecessarily responding to an advertising message transmitted toward a different device.

Furthermore, since a target address is set, a provider can efficiently bootstrap a specific peer.

Furthermore, the address of a device bonded using a public address or a random address may be used as the target address. In this case, any one of the methods described with reference to FIGS. 18 to 20 may be applied.

The first device forms a Bluetooth LE connection with the second device (S2302).

The second device may form the Bluetooth LE connection with the first device based on the advertising message received at step S2301.

As described above, an advertising message in which a target address has been previously set may be considered to be direct advertising for a connection with the device of the target address. In this case, the second device may send a connection request message to the first device.

The first device and the second device may be connected simultaneously with the connection request of the second device. In this case, prior to S2302, the first device may send a request message that requests a Bluetooth LE connection to the second device.

The first device sends a write request message, including control information for indicating the ON of Bluetooth BR/EDR, that is, an alternative communication technology to be connected, and the activation of a specific service, to the second device (S2303).

In this case, the first device may request the writing of a “control point” characteristic in order to indicate the ON of the Bluetooth BR/EDR (or mode change) and the activation of the specific service through the write request message.

Furthermore, the control information may include Opcode for indicating a specific operation for the second device and a parameter value therefor.

The first device receives a write response message as a response to the write request message (S2304).

The second device may turn on the Bluetooth BR/EDR, that is, alternative communication means, and activate the specific service in response to an instruction from the first device. In this case, the second device may activate only part of or the entire service instructed by the first device.

At steps S2303 and S2304, the request message and the response message may be transmitted through an advertising channel using Bluetooth LE. In this case, step S2302 may be omitted. In other words, in such a case, a BR/EDR handover request/response may be transmitted and received as an advertising message without the intervention of a BLE connection procedure.

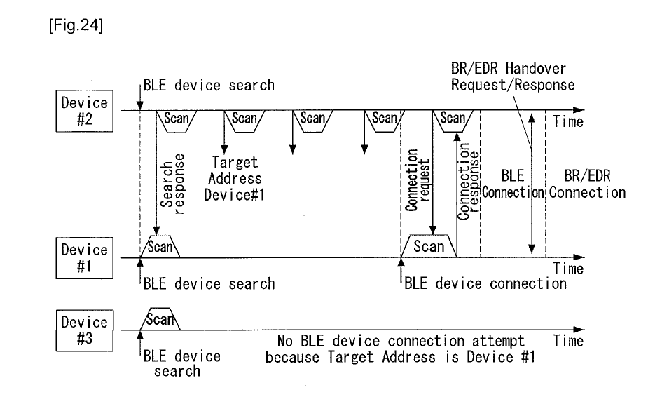

FIG. 24 is a diagram schematically showing an example of handover from Bluetooth LE to the Bluetooth BR/EDR, which is proposed by this specification.

FIG. 24 schematically shows a process of performing a Bluetooth BR/EDR connection through the Bluetooth LE connection described with reference to FIGS. 15 to 23. It may be seen that a scan section has been reduced compared to the process of FIG. 8.

The reason for this is that a process of searching for, by two devices in a non-connection state, a counterpart device for a Bluetooth BR/EDR connection does not need to be performed because the two devices have already been connected through Bluetooth LE.

Furthermore, if the second device has only to add (or insert) the first device into a target address and to perform advertising, it may scan only the second device and perform BR/EDR handover. Power consumption for scanning and a packet processing process can be reduced because the third device not inserted into the target address does not process the advertising.

Furthermore, handover can be efficiently performed because information for a Bluetooth BR/EDR connection is obtained through a handover request message and a handover response message.

The present invention is not limited and applied to the configurations and methods of the aforementioned embodiments, but some or all of the embodiments may be selectively combined and configured so that the embodiments are modified in various ways.

Furthermore, the present invention described above may be substituted, modified or changed by a person having ordinary skill in the art to which the present invention pertains without departing from the technological spirit of the present invention, and thus is not restricted by the aforementioned embodiments and the accompanying drawings.

Furthermore, in this specification, both the device invention and the method invention have been described, but the descriptions of both the inventions may be complementally applied, if necessary.

This specification relates to the transmission and reception of Bluetooth data and, more particularly, to a method and apparatus for performing a Bluetooth BR/EDR connection using a Bluetooth low energy (BLE) technology.

In accordance with an embodiment of the present invention, a surrounding device that supports the Bluetooth BR/EDR and services that may be provided through the Bluetooth BR/EDR can be discovered through Bluetooth LE.

Furthermore, in accordance with an embodiment of the present invention, user convenience can be improved by providing information about devices discovered through Bluetooth LE to a user.

Furthermore, in accordance with an embodiment of the present invention, consumption power for device discovery can be reduced because a Bluetooth BR/EDR connection is formed by exchanging information for the Bluetooth BR/EDR connection with a discovered device through Bluetooth LE method.

Furthermore, in accordance with an embodiment of the present invention, consumption power can be reduced by providing a service by exchanging information for providing a Bluetooth BR/EDR service with a discovered device through Bluetooth LE.

Furthermore, in accordance with an embodiment of the present invention, the protection of personal information can be enhanced because only a bonded device is allowed for discovery and connection.

Furthermore, in accordance with an embodiment of the present invention, the state of a surrounding device can be immediately checked by always discovering a device through Bluetooth LE.

Advantages which may be obtained by the present invention are not limited to the aforementioned advantages, and various other advantages may be evidently understood by those skilled in the art to which the present invention pertains from the following description.

What is claimed is:

1. A method for forming, by a second device, a Bluetooth BR/EDR connection with a first device using Bluetooth LE, the method comprising:
transmitting an advertising message to a plurality of devices through Bluetooth LE, wherein the advertising message includes a target address indicating a device which receives the advertising message;
receiving a first request message including first control information instructing a Bluetooth BR/EDR connection from the first device indicated by the target address;
transmitting a first response message to the first device in response to the first request message; and
forming the Bluetooth BR/EDR connection with the first device for providing a specific service.

2. The method of claim 1, wherein the first request message and the first response message are transmitted through an advertising channel using the Bluetooth LE.

3. The method of claim 1, further comprising forming a Bluetooth LE connection with the first device based on the advertising message.

4. The method of claim 3, wherein:
forming the Bluetooth LE connection comprises receiving a second request message to request the Bluetooth LE connection from the first device in response to the advertising message, and
the Bluetooth LE connection is formed between the first device and the second device based on the second request message.

5. The method of claim 1, wherein:
the target address indicates of a public address or a random address, and
the public address or the random address indicates an address used when the first device and the second device perform a bonding procedure.

6. The method of claim 1, wherein the advertising message further includes at least one of a state information indicating an on or off of Bluetooth BR/EDR, a service list information indicating at least one of service capable of providing through the Bluetooth BR/EDR, or ab ID information indicating the second device.

7. The method of claim 6, wherein:
the ID information indicating the second device indicates a public address or a random address, and
the public address or the random address indicates an address used when the first device and the second device perform a bonding procedure.

8. The method of claim 7, wherein the first request message is transmitted by the first device based on the ID information.

9. The method of claim 3, wherein if the specific service is a data synchronization service, the first request message includes a second control information instructing an activation of a data synchronization function of the second device.

10. The method of claim 9, further comprising:
receiving a third request message to request a writing of data for providing the data synchronization service from the first device through the Bluetooth LE, wherein the third request message comprises the data; and
transmitting a second response message to the first device in response to the third request message.

11. A second device for forming a Bluetooth BR/EDR connection with a first device using Bluetooth LE, the device comprising:
a communication unit configured to perform communication with an outside in a wired or wireless manner; and
a processor functionally connected to the communication unit,
wherein the processor is configured to:
transmit an advertising message to a plurality of devices through Bluetooth LE, wherein the advertising message includes a target address indicating a device which receives the advertising message,
receive a first request message including first control information instructing a Bluetooth BR/EDR connection from the first device indicated by the target address,
transmit a first response message to the first device in response to the first request message, and
form the Bluetooth BR/EDR connection with the first device for providing a specific service.
